(19) United States
(12) Patent Application Publication
(10) Pub. No.: US 2026/0189957 A1
(43) Pub. Date: Jul. 2, 2026

(54) METHOD AND APPARATUS FOR PERFORMING AND REPORTING EARLY MEASUREMENTS BASED ON PREDICTED UL AND/OR DL DATA

(71) Applicant: INTERDIGITAL PATENT HOLDINGS, INC., Wilmington, DE (US)

(72) Inventors: Oumer TEYEB, Montreal (CA); Yugeswar DEENOO, Chalfont, PA (US)

(73) Assignee: INTERDIGITAL PATENT HOLDINGS, INC., Wilmington, DE (US)

(21) Appl. No.: 19/116,839

(22) PCT Filed: Sep. 28, 2023
(86) PCT No.: PCT/US2023/033975

§ 371 Date: Mar. 28, 2025

Related U.S. Application Data
(60) Provisional application No. 63/410,681, filed on Sep. 28, 2022.

(51) Int. Cl. H04W 24/10; H04L 41/16; H04W 24/08

(52) U.S. Cl. CPC H04W 24/10; H04L 41/16; H04W 24/08

(57) ABSTRACT

An embodiment includes a WTRU configured to receive configuration information indicating a trigger condition for measurements to be performed while operating in a first activity level, receive an indication to transition from operating in a second activity level to operating in the first activity level, perform measurements, while operating in the first activity level, responsive to a predicted fulfillment of the trigger condition, and transmit a report based on the measurements responsive to transitioning to the second activity level. For example, a WTRU can be configured to perform UL/DL traffic prediction and early measurements while in an IDLE/INACTIVE state, and to transmit a report based on the measurements responsive to transitioning to a CONNECTED state. The report may include measurements performed and/or indicate whether a CA/DC configuration would allow the WTRU to fulfill UL/DL traffic demands. The WTRU also may refrain from performing the measurements and/or including the measurement report.

### CROSS-REFERENCE TO RELATED APPLICATIONS

This application claims the benefit of U.S. Provisional Application No. 63/410,681, filed Sep. 28, 2022, the contents of which are incorporated herein by reference.

### SUMMARY

An embodiment of an apparatus or device includes a WTRU configured to perform UL/DL traffic prediction and early measurements while in an IDLE/INACTIVE mode, wherein the WTRU configuration also includes conditions/associations between the Uplink/Downlink (UL/DL) traffic prediction and early measurements.

One or more embodiments are related to Artificial-Intelligence/Machine-Learning (AI/ML) and UL/DL Traffic Prediction, such as early measurements for Cellular-Automation/Dual-Connectivity (CA/DC) and UL/DL traffic prediction.

In an embodiment, a WTRU (e.g., a UE) is configured to perform UL/DL traffic prediction and early measurements while in IDLE/INACTIVE (e.g., in an IDLE/INACTIVE move), where the WTRU configuration also includes conditions/associations between the two (e.g., the WTRU is configured to perform the early measurements only when the predicted traffic volume is above a certain level, or the traffic is of a certain Quality of Service (QoS).

In an embodiment, a WTRU is configured to perform UL/DL traffic prediction while in IDLE/INACTIVE, and is configured to monitor the conditions associated with starting the early measurements and to start to perform the early measurements when the conditions are fulfilled.

In an embodiment, upon connection setup or resume, a WTRU includes current and predicted buffer levels (e.g., predicted Buffer Status Report(s) (BSR) and current BSR).

In an embodiment, upon connection setup or resume, a WTRU includes additional information such as whether CA/DC is needed to accommodate current and predicted traffic levels/types, reason(s) why early measurement is not performed or an early measurement report is not included, etc.

In an embodiment, a wireless transmit/receive unit (WTRU) is configured to receive configuration information indicating a trigger condition for performing measurements, to perform measurements responsive to a predicted fulfillment of the trigger condition, and to transmit a report based on the measurements.

In an embodiment, a WTRU does the following:
receives (e.g., from a network or from another WTRU) one or more of the following configurations:
   early measurements (e.g., during a transition from a CONNECTED mode to an INACTIVE or IDLE mode);
   predictions regarding UL or/and DL data arrival (e.g., time horizons, desired accuracy levels);
   relationship between the performance of early measurements and predicted UL/or DL data (e.g., early measurement to be started when UL data of at least X KBs is expected to arrive within n milliseconds (ms), with an accuracy of p %);
transitions from CONNECTED mode to IDLE/INACTIVE (e.g., reception of a Radio-Resource-Control (RRC) Release message);
does not start performing early measurements immediately on transitioning to IDLE/INACTIVE mode;
performs UL/DL data prediction;
upon detecting conditions for starting early measurements based on predicted data are fulfilled, starts performing the early measurements;
upon arrival of UL data or reception of paging indicating DL data, initiates an RRCSetup or RRCResume procedure; and
sends the results (e.g., to the network or to another WTRU) of performing the early measurements during or at the completion of the RRCSetup or RRCResume procedure.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A, according to an embodiment;

FIG. 1C is a system diagram illustrating an example radio access network (RAN) and an example core network (CN) that may be used within the communications system illustrated in FIG. 1A. according to an embodiment;

FIG. 1D is a system diagram illustrating a further example RAN and a further example CN that may be used within the communications system illustrated in FIG. 1A, according to an embodiment;

FIGS. 2-3 illustrate RRC connection establishment/setup connect resume procedures;

FIG. 4 summarizes the different RRC modes and the transitions between the different RRC modes;

FIG. 5 illustrates early measurements that can be used for a quick setup of CA/DC when a WTRU goes to RRC_CONNECTED from RRC_INACTIVE;

FIGS. 6A-6C show sample BSR formats.

FIG. 7 shows a WTRU compiling and transferring WTRU capability information upon receiving a UECapabilityEnquiry message from the network by sending a UECapabilityInformation message;

FIG. 8 is a diagram of a potential problem with current mechanisms for early measurement configuration;

FIG. 9 is a diagram that illustrates another potential problem with current mechanisms for early measurement configuration;

FIG. 10 is a diagram that illustrates a WTRU being provided with the configurations (while in a CONNECTED mode or upon transitioning to an INACTIVE mode) related to an early measurement configuration that is dependent on traffic prediction, according to an embodiment;

FIG. 11 is a diagram that illustrates a scenario where the WTRU determines that there is no need for setting up CA/DC, according to an embodiment;

FIG. 12 is a diagram that illustrates a WTRU being provided with one or more configurations (while in a CONNECTED mode or upon transitioning to an INACTIVE mode) related to an early measurement configuration that is dependent on traffic prediction, according to another embodiment; and

FIG. 13 is a flow diagram of a WTRU implemented method for performing a measurement in response to fulfillment of a trigger condition and reporting the results, according to an embodiment.

### DETAILED DESCRIPTION

The following are abbreviations and acronyms used herein.
AMF Access and Mobility Management Function
A Aperiodic
BS Base Station
BWP Bandwidth Part
CCE Control Channel Element
CORESET Control Resource Set
CRC Cyclic Redundancy Check
CSI Channel State Information
CSI-RS Channel State Information RS
DCI Downlink Control Information
DL Downlink
DMRS Demodulation Reference Signal
FDD Frequency Division Duplex
FDM Frequency Division Multiplexing
FDMA Frequency Division Multiple Access
FDRA Frequency Domain Resource Allocation
FR1 Frequency Range 1
FR2 Frequency Range 2
HARQ-ACK Hybrid Automatic Repeat Request Acknowledgement
ID Identity, also index
IM Interference Measurement
MAC Medium Access Control
MAC CE MAC Control Element
MCS Modulation and Coding Scheme
MIMO Multiple Input Multiple Output
MU-MIMO Multi-User MIMO
NDI New Data Indicator
NR New Radio
NZP Non-Zero Power
OFDM Orthogonal Frequency Division Multiplexing
PBCH Physical Broadcast Channel
PDCCH Physical Downlink Control Channel
PDSCH Physical Downlink Shared Channel
PSCCH Physical Sidelink Control Channel
PSSCH Physical Sidelink Shared Channel
PUCCH Physical Uplink Control Channel
PUSCH Physical Uplink Shared Channel
QAM Quadrature Amplitude Modulation
QCL Quasi Co-location
QPSK Quadrature Phase Shift Keying
RAN Radio Access Technology
RE Resource Element
REG Resource Element Group
RRC Radio Resource Control
RS Reference Signal
RSRP RS Received Power
RV Redundancy Version
Rx Receive, Receiver, or Reception
Scell Secondary Cell
SCI Sidelink Control Information
SDM Spatial Division Multiplexing
SINR Signal to Interference plus Noise power Ratio
SLIV Start and Length Indicator Value
SNR Signal to Noise power Ratio
SP Semi-persistent
SRI SRS Resource Indicator
SRS Sounding RS
SSB Synchronization Signal/PBCH Block
SUL Supplemental Uplink
TB Transport Block
TCI Transmission Configuration Indicator
TDD Time Division Duplex
TDM Time Division Multiplexing
TDRA Time Domain Resource Allocation
TRP Transmission and Reception Point
TRS Tracking RS (also CSI-RS for tracking)
Tx Transmit, Transmitter, or Transmission
UCI Uplink Control Information
UE User Equipment; UE and WTRU are used interchangeably herein
UL Uplink
WTRU Wireless Transmit/Receive Unit; UE and WTRU are used interchangeably herein
ZP Zero-Power

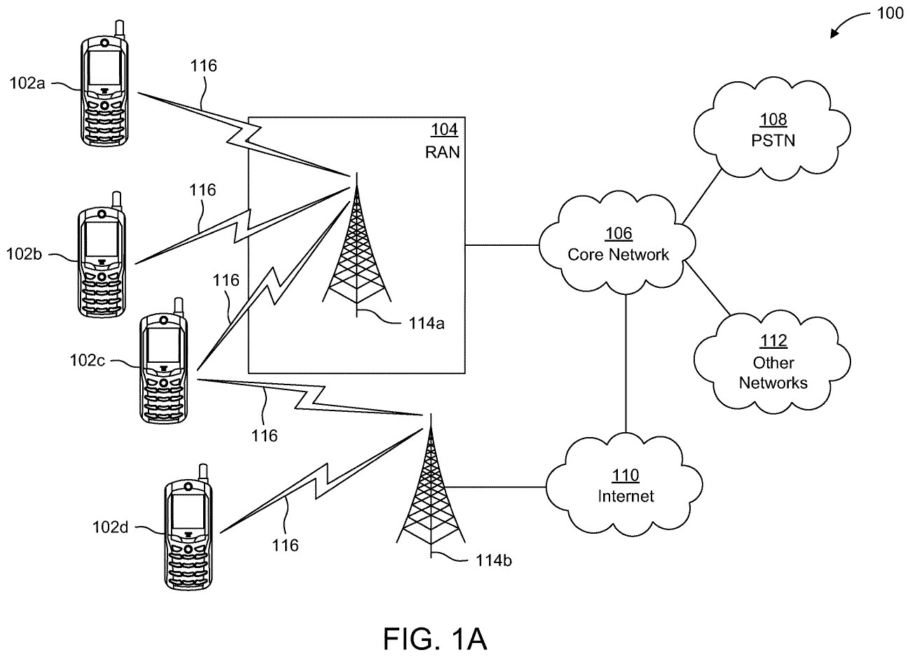

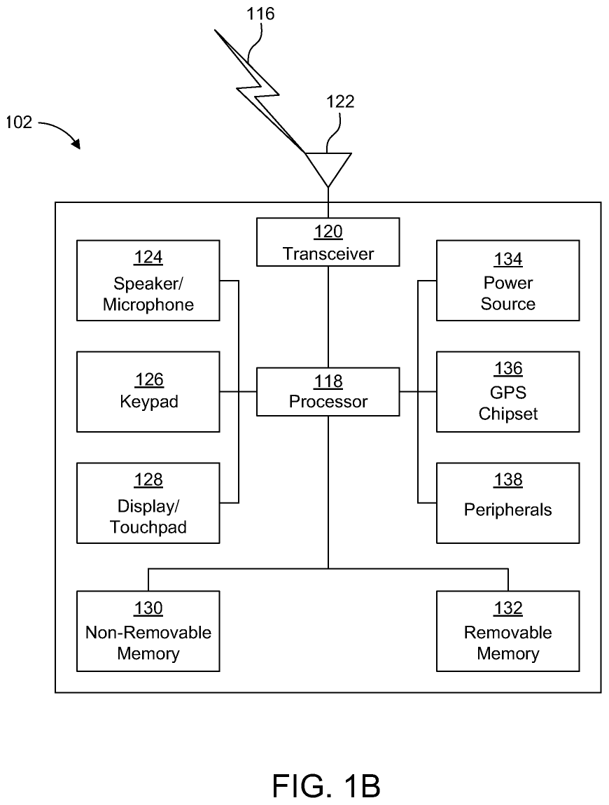

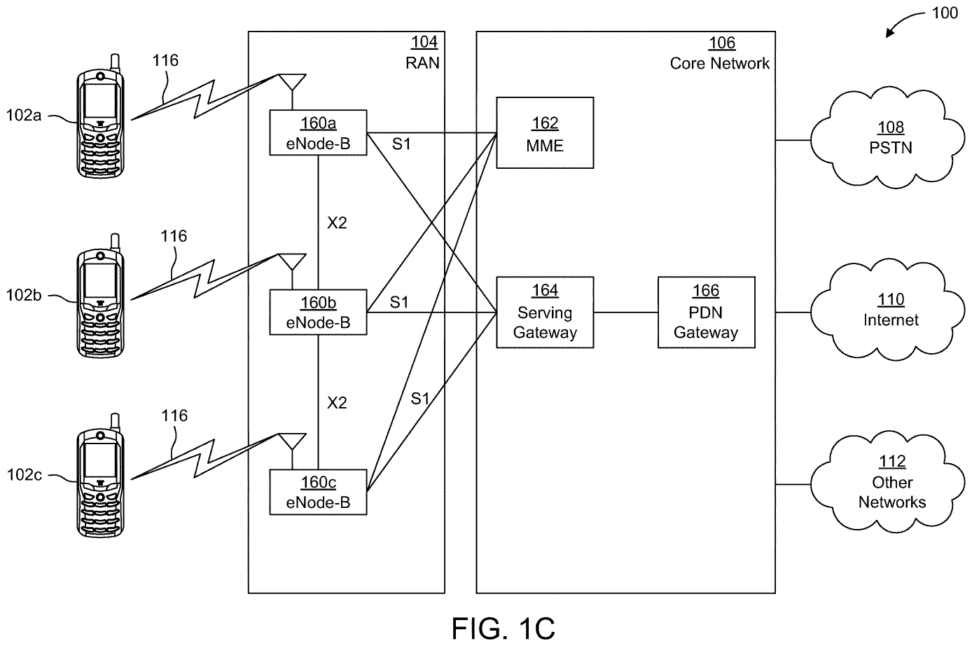

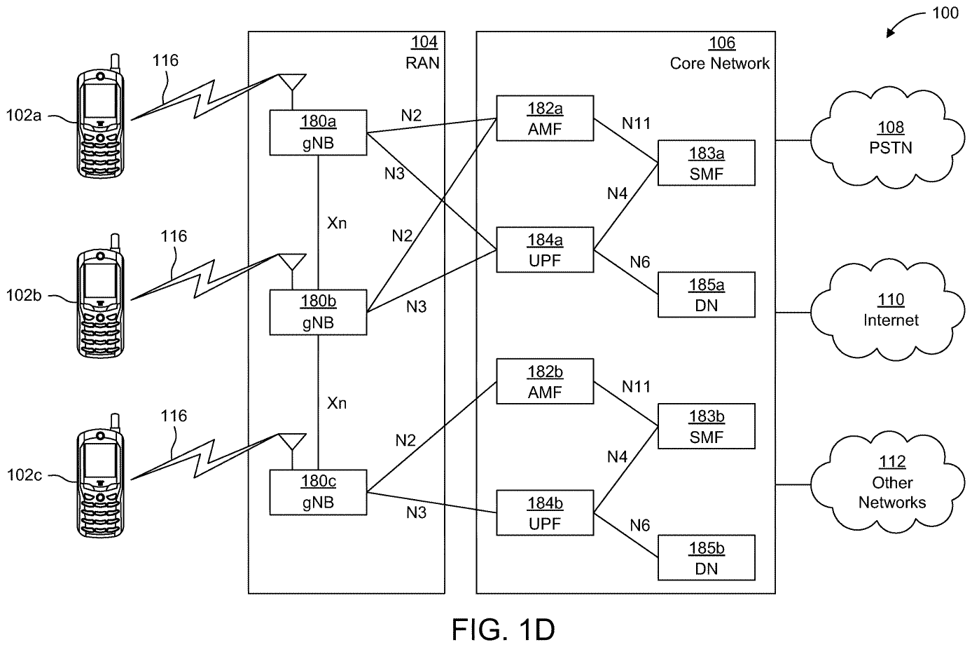

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel-access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique-word OFDM (UW-OFDM), resource block-filtered OFDM, filter-bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple-access system and may employ one or more channel-access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over-the-air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality, and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio-resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In NR, a WTRU can be in one of the following three RRC modes:
RRC_CONNECTED (also referred to as “CONNECTED” or “CONNECTED mode” herein)
RRC_INACTIVE (also referred to as “INACTIVE” or “INACTIVE mode” herein)
RRC_IDLE (also referred to as “IDLE” OR “IDLE mode” herein)

In the RRC_CONNECTED mode, a WTRU is actively connected to the network, with signaling and data radio bearers established (SRB and DRBs), and able to receive Downlink (DL) data from the network in a unicast fashion and also to send Uplink (UL) data to the network. The mobility of the WTRU from one cell/node to another is controlled by the network, which may configure the WTRU to send measurement reports periodically or when certain conditions are fulfilled (e.g., a neighbor cell becomes better than a serving cell by more than a certain threshold), and based on these reports the network may send to the WTRU a handover command to move the WTRU to another cell/node. The network may also configure a conditional handover, CHO, where instead of sending of a measurement report, the WTRU executes a preconfigured handover command when certain conditions are fulfilled. The network may also send the WTRU a HO command without receiving any measurement report (e.g., based on an implementation, such as the determination of current location).

Keeping the WTRU in connected mode is power intensive for the WTRU (e.g., the WTRU needs to continuously monitor the PDCCH of the serving cell, e.g., for determining the arrival of DL data, for UL data scheduling, etc.), and a certain cell/gNB is able to accommodate a certain number of WTRUs in connected mode (e.g., due to resource limitations). As such, when there is no activity in the UL or DL for a certain duration (e.g., based on an inactivity timer kept at the network), the network may send the WTRU to the RRC_INACTIVE or RRC_IDLE mode.

If the network expects the WTRU to become inactive for a long duration, it can send the WTRU to the RRC_IDLE mode. While in the RRC_IDLE mode, the WTRU camps at the best cell (the cell with the best signal level at the highest priority RAT and highest priority frequency within that RAT) that will facilitate the WTRU establishing the connection via that cell if a need arises for the WTRU to transition back to the connected mode. The WTRU also monitors the downlink paging channel to detect for DL data arrival. The WTRU will initiate the connection setup/establishment procedure if it detects a paging from the network indicating an arrival of a DL data or if the WTRU is to send a UL data.

During connection setup or resume, the WTRU first performs a random access (RA) procedure (also referred to as Random Access Channel, RACH, procedure herein) before sending the RRCSetupRequest or the RRCResumeRequest message. The RA procedure serves at least two main purposes:
get UL synchronization between the UE and the network (e.g., gNB)
obtain the resources that are to be used for the sending of the request message.

During the RA procedures, the WTRU sends a message on the RACH (referred to as msg1), that contains a Preamble and an RA-RNTI (Random Access-Radio Network Temporary Identifier) to the gNB. In the case of contention based random access (CBRA), the preamble is randomly selected out of a set of possible preamble values (i.e., there could be a contention if another WTRU initiates a random access procedure using the same preamble value). In the case of contention free random access (CFRA), a specific preamble is provided to the WTRU beforehand (e.g., when the WTRU was in the CONNECTED mode, during the transition to the IDLE/INACTIVE mode, etc.,). The RA-RNTI is calculated based on the PRACH (physical RACH) occasion at which the random-access message is to be sent to the network.

The gNB, upon receiving msg1, responds with msg2, which contains a Random Access Response (RAR). In order for the WTRU to get the RAR, the network also sends a DCI (Downlink Control Indicator) in the PDCCH that is scrambled with the RA-RNTI, which is used by the WTRU to determine on which resources (i.e., time and frequency) that RAR (and other related info) is provided to the WTRU. The WTRU tries to detect this DCI within a period of time after sending the preamble (known as the RAR-window). If such DCI is not received, the WTRU may retransmit the preamble again. If the DCI is received, the WTRU will get the RAR at the indicated time and frequency resources in the PDSCH. In the RAR and associated information, the WTRU will be provided with the timing advance (TA) to apply for sending UL data, the TC-RNTI (temporary Cell RNTI), and the UL resources to send the setup/resume request message.

The WTRU may get the detailed information/configuration regarding the usage of the random access channel, such as RACH occasion, random access response window, etc, via dedicated configuration while in the CONNECTED mode, upon transitioning during an IDLE/INACTIVE mode, or from system information broadcast (SIB).

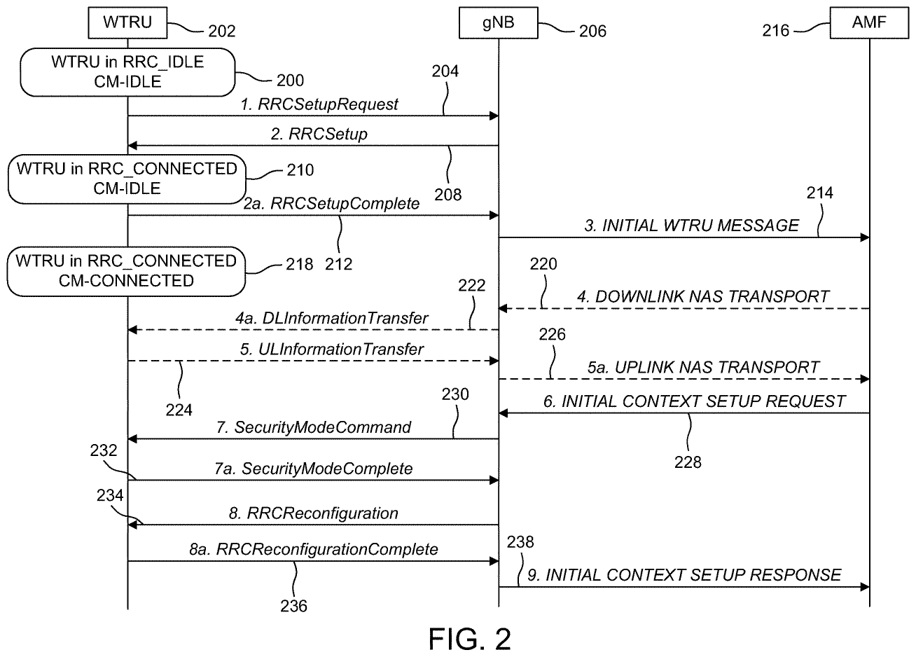

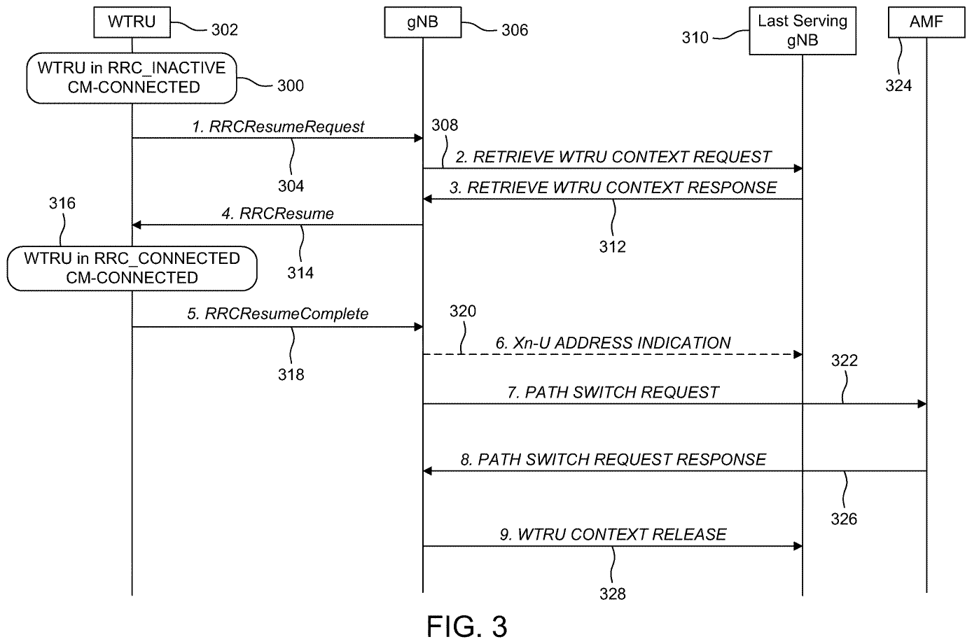

FIGS. 2-3 illustrate the RRC connection establishment/setup and connection resume procedures, according to one or more embodiments.

Referring to FIG. 2, at 200, a WTRU 202 is in a Connection-Management (CM)-IDLE Mode and an RRC-IDLE Mode.

At 204 (message1), the WTRU 202 sends an RRCSetupRequest message to a gNB 206.

Next, at 208 (message2), the gNB 206 sends an RRCSetup message to the WTRU 202.

Then, at 210, the WTRU 202 is in a CM-IDLE Mode and an RRC-CONNECTED Mode.

Next, at 212 (message2a), the WTRU 202 sends an RRCSetupComplete message to the gNB 206.

Then, at 214 (message3), the gNB 206 sends an Initial WTRU Message to an AMF 216.

Next, at 218, the WTRU 202 is in a CM-CONNECTED Mode and an RRC-CONNECTED Mode.

Then, at 220 (message4), the AMF 216 sends a DOWNLINK NAS TRANSPORT message to the gNB 206.

Next, at 222 (message4a), the gNB 206 sends a DLInformationTransfer message to the WTRU 202.

Then, at 224 (message5), the WTRU 202 sends a ULInformationTransfer message to the gNB 206.

Next, at 226 (message5a), the gNB 206 sends an UPLINK NAS TRANSPORT message to the AMF 216.

Then, at 228 (message6), the AMF 216 sends an INITIAL CONTEXT SETUP REQUEST message to the gNB 206.

Next, at 230 (message7), the gNB 206 sends a SecurityModeCommand message to the WTRU 202.

Then, at 232 (message 7a), the WTRU 202 sends a SecurityModeComplete message to the gNB 206.

Next, at 234 (message8), the gNB 206 sends an RRCReconfiguration message to the WTRU 202.

Then, at 236 (message8a), the WTRU 202 sends an RRCReconfigurationComplete message to the gNB 206.

Next, at 238, the gNB 206 sends an INITIAL CONTECT SETUP RESPONSE message to the AMF 216.

Referring to FIG. 3, at 300, a WTRU 302 is in a Connection-Management (CM)-Connected Mode and an RRC-INACTIVE Mode.

Then, at 304 (message1), the WTRU 302 sends an RRCResumeRequest message to a gNB 306.

Next, at 308 (message2), the gNB 306 sends a RETRIEVE WTRU CONTEXT REQUEST message to a Last Serving gNB 310.

Then, at 312 (message3), the Last Serving gNB 310 sends a RETRIEVE WTRU CONTEXT RESPONSE message to the gNB 306.

Next, at 314 (message4), the gNB 306 sends an RRCResume message to the WTRU 302.

Then, at 316, the WTRU 302 is in a CM-CONNECTED Mode and an RRC-CONNECTED Mode.

Next, at 318 (message5), the WTRU 302 sends an RRCResumeComplete message to the gNB 306.

Then, at 320 (message6), the gNB 306 sends an Xn-U ADDRESS INDICATION message to the Last Serving gNB 310.

Next, at 322 (message7), the gNB 306 sends a PATH SWITCH REQUEST message to an AMF 324.

Then, at 326 (message8), the AMF 324 sends a PATH SWITCH REQUEST RESPONSE message to the gNB 306.

Next, at 328 (message9), the gNB 306 sends a WTRU CONTEXT RELEASE message to the Last Serving gNB 310.

NOTE: Referring to FIGS. 2-3 (the following msg numbers may not correspond to the preceding message numbers in FIGS. 2-3).

The term msg3 is used herein to refer to RRCResumeRequest or RRCSetupRequest.
The term msg4 is used herein to refer to RRCResume or RRCSetup.
The term msg5 is used herein to refer to RRCResumeComplete or RRCSetupComplete.
If the WTRU 202/302 resumes the connection in the same gNB 206/306, messages 2, 3, and 6 to 9 may not be required, and as such the WTRU can be resumed without involving the Core Network (CN).

As can be seen above and in FIGS. 2-3, the RRC connection setup procedure can be a lengthy procedure that may take several round trip times to complete and it can involve the CN. This is because when the WTRU 202/302 goes to IDLE mode, the WTRU's RRC context is released, and as such the WTRU is not known at the RAN level, so, the RAN obtains the WTRU context from the CN. Also, security is re-established after that and the WTRU 202/302 is reconfigured with the DRBs and SRBs, before UL/DL data transmission/reception occurs.

Such a lengthy setup procedure may not be compatible with low-latency services, and, thus, NR has introduced an intermediate state between the CONNECTED and IDLE modes, known as the INACTIVE mode. The INACTIVE mode has most of the power saving advantages of the IDLE mode (e.g., the WTRU 202/302 may, but is not required to, continuously monitor the PDCCH, which is one of the most power-consuming procedures in the CONNECTED mode), but at the same time, the RAN still keeps the WTRU's RRC/Security context. When the WTRU 202/302 transitions to the CONNECTED mode (e.g., due to the arrival of UL data or the reception of a paging indicating the arrival of DL data), the connection may be resumed quickly, for example, without involving the CN, without re-establishing the WTRU's security context, and without reconfiguring the bearers.

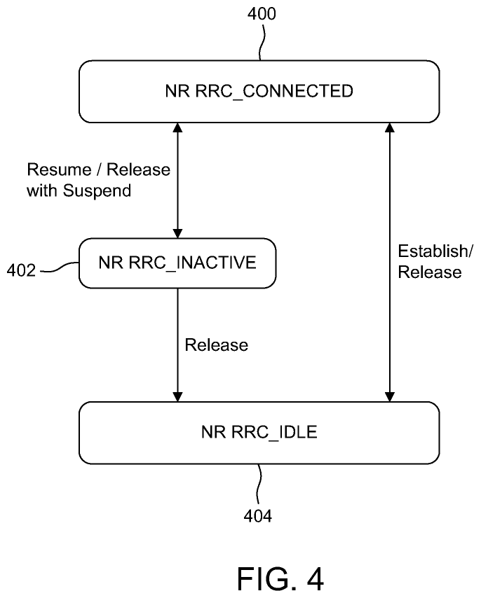

FIG. 4 summarizes the different RRC modes and the transitions between them.

For example, at 400, a WTRU (not shown in FIG. 4) is in the NR RRC-CONNECTED Mode.

The WTRU can transition to the intermediate NR RRC-INACTIVE Mode at 402 or directly to the NR RRC-IDLE Mode at 404.

While in the NR RRC-INACTIVE Mode at 402, the WTRU can transition back to the NR RRC-CONNECTED Mode at 400 or to the NR RRC-IDLE Mode at 404.

And, while in the NR RRC-IDLE Mode at 404, the WTRU can transition back to the NR RRC-CONNECTED Mode at 400.

Referring to FIGS. 2-4, when a WTRU (e.g., the WTRU 202/302) performs the connection setup/establishment or resume procedure, it includes (in the RRCSetupRequest or RRCResumeRequest), the establishment or resume cause. Currently, the following causes are defined.

```
EstablishmentCause : := ENUMERATED {
                                    emergency, highPriorityAccess, mt-Access, mo-
Signalling,
                                    mo-Data, mo-VoiceCall, mo-VideoCall, mo-SMS,
                                    mps-PriorityAccess, mcs-PriorityAccess, spare6,
    spare5, spare4, spare3, spare2, spare1}
ResumeCause : : =, ENUMERATED { emergency, highPriorityAccess, mt-Access, mo-
Signalling,
                                    mo-Data, mo-VoiceCall, mo-VideoCall, mo-SMS, rna-
        Update, mps-PriorityAccess, mcs-PriorityAccess,
                                                              sparel, spare2, spare3,
        spare4, spare5 }
```

For example, if the connection is being setup/resumed due to a voice call or video call originating from the WTRU, the WTRU will set the establishment/resume cause to mo-VoiceCall (mobile-originated voice call) or mo-VideoCall (mobile-originated video call). As another example, if the connection is being setup/resumed due to downlink paging indicating DL data, the WTRU will set the establishment/resume cause to one of mt-Access (mobile-terminated access), highPriorityAccess, mps-PriorityAccess, or mcs-PriorityAccess (depending on the access category of the WTRU).

When the WTRU is sent to the NACTIVE mode, the network includes in the RRCRelease message a suspendConfig. The SuspendConfig contains information such as:
the resumeldentity to be used by the WTRU (a short identity, shortl-RNTI, and a long identity, fulll-RNTI). The WTRU determines which identity to use based on the system information broadcast in the target cell (e.g., if useFullResumeID is indicated in the SIB, use the long identity, otherwise, use the short identity).
The RAN paging area (e.g., list of cells): this is the RAN area where the WTRU can be paged at the RAN level. If the WTRU performs cell re-selection to a cell outside the RAN area, the WTRU performs the RAN area update procedure.
nextHopChaining count: this is used for deriving the security context (e.g., encryption/integrity protection keys) upon resuming the connection.

The mechanism used for RAN area update is sometimes referred to as a “2 step resume” procedure, because the WTRU sends a ResumeRequest indicating a cell re-selection outside the RAN area, and the network responds with a Release message (e.g., including a new RAN area configuration). That is, the WTRU will remain in INACTIVE mode, and the network now has information regarding in which RAN area the WTRU is, or can be, accessible, if there is a need to page the WTRU (e.g., arrival of DL data at the RAN that is intended for the WTRU).

In relation to measurements in RRC_IDLE and RRC_INACTIVE, the network may configure a WTRU with Carrier Aggregation (CA) or/and Dual Connectivity (DC) in order to increase the data rate per user (and in some cases, increase reliability as well). In CA, the WTRU simultaneously sends/receives data to/from multiple cells of a given gNB that are operating at different carrier frequencies. In DC, on the other hand, the WTRU is connected to two serving gNBs, known as the master node (MN) and the secondary node (SN). When operating in DC, the WTRU may be further configured in CA within the MN and/or the SN. The set of cells under the MN that are configured for the WTRU are known as Master Cell Group (MCG), and the ones under the SN are referred to as Secondary Cell Group (SCG). The primary cell in the MCG is referred to as PCell, and the primary cell in the SCG is known as PSCell. The term SPCell (special Cell) is used to refer to either the PCell or the PSCell. The cells other than the SPCells are known as SCell (Secondary Cells).

The network normally decides to setup CA and/or DC for a WTRU based on measurement reports received from the WTRU regarding neighboring cells (though there is nothing preventing the network from configuring CA or/and DC blindly).

In order to enable the quick setup of CA and/or DC as soon as the WTRU transitions into RRC_CONNECTED, it has been known to introduce early measurement reporting (also known as IDLE/INACTIVE measurements), where the WTRU can be configured to perform measurements on neighboring cells (intra-frequency, inter-frequency, or/and inter-RAT neighbor cells) while it is in RRC_INACTIVE or RRC_IDLE. When the WTRU transitions to the RRC_CONNECTED mode, the WTRU can send the measurements, letting the network know if there are candidate neighbor cells that can be configured in CA or DC mode for the WTRU.

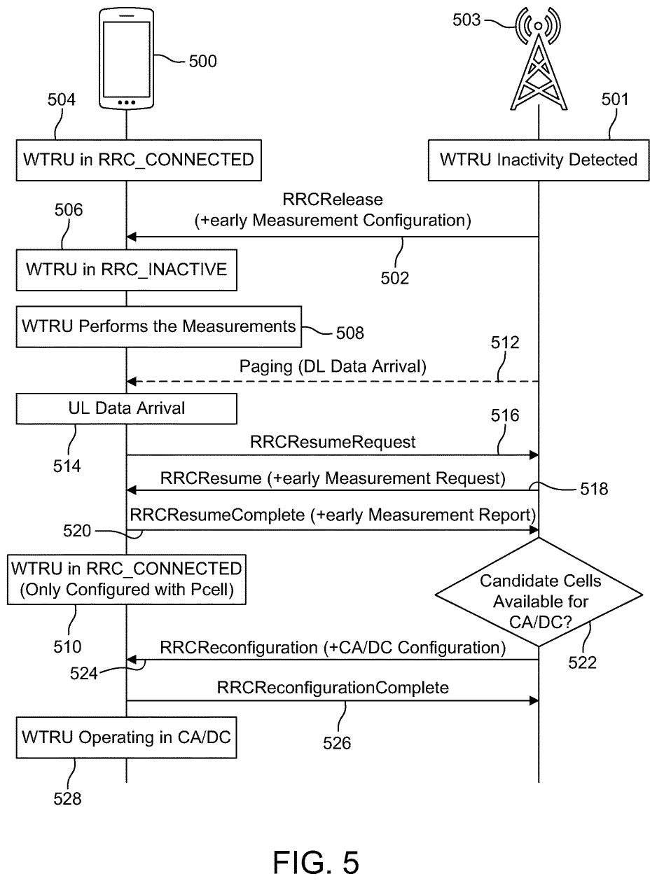

FIG. 5 illustrates early measurements that can be used for a quick setup of CA/DC when a WTRU 500 goes to an RRC_CONNECTED Mode from an RRC_INACTIVE Mode. At 501, a network 503 detects that the WTRU 500 is exhibiting no activity. At 502, the WTRU 500 is provided by the network 503 with at least one early-measurement configuration upon transitioning from RRC-CONNECTED 504 to RRC_INACTIVE 506, and the WTRU configures itself according to the early-measurement configuration. At 508, the WTRU 500 performs the measurements while the WTRU is in RRC_INACTIVE. When the WTRU 500 transitions to RRC_CONNECTED mode 510 (e.g., at 512 due to having received a paging due to DL data arrival, or UL data arrives at 514 and is to be sent, etc), the WTRU will trigger the RRC Resume procedure by sending, at 516, the RRC Resume Request message. At 518, the network 503 can request the WTRU 500 to send the measurements performed during RRC_INACTIVE mode in the RRC Resume message, which the WTRU will provide in the RRCResumeComplete message at 520. Based on that, the network 503 can, as soon as immediately, configure CA/DC, if such candidate cells are available at 522.

If such candidate cells are available at 522, then the network 503 sends, to the WTRU 500 at 524, an RRCReconfiguration message that can include CA/DC configuration information.

Next, at 526, the WTRU 500 sends to the network 403 an RRCReconfigurationComplete message, and thereafter operates in a CA/DC mode at 528 according to the CA/DC configuration information sent to the WTRU by the network 503.

Still referring to FIG. 5, without early measurements (e.g., NR rel-15), the setup of CA/DC may have been considerably delayed as the WTRU 500 is to be configured with measurements to perform after the transition to RRC_CONNECTED, and the network 503 typically waits until the WTRU has performed these measurements and has sent the measurement report before configuring CA/DC.

The IDLE/INACTIVE measurement configuration can be provided to the WTRU 500 either via dedicated message (in, e.g., measIdleConfig information element (IE) in the RRCRelease message when the WTRU is transitioned to IDLE/INACTIVE) or the WTRU may get obtain the IDLE/INACTIVE measurement configuration from a System Information Block (SIB) 11 (in measIdleConfig-SIB IE).

The meas/dleConfig IE basically can contain one or more of the following conventional items:
List of NR carrier frequencies to be measured (for CA or DC candidate NR cells). This may contain additional information such as the list of cells to be measured, the quality to be measured (e.g., RSRP or RSRQ), RSRP/RSRQ thresholds indicating which cells are to be included in the measurement report, details of SSB and beam configurations, etc.
List of EUTRA (i.e., LTE) frequencies (for inter-RAT candidate cells for DC with NR, e.g., EN-DC, NE-DC). This may contain additional information such as the list of cells to be measured, the quality to be measured (e.g., RSRP and/or RSRQ), RSRP/RSRQ thresholds indicating which cells are to be included in the measurement report, etc.
Idle measurement duration (a value that can be from about 10 seconds to 300 seconds): This specifies for how long the WTRU 500 keeps performing the measurements while in IDLE/INACTIVE;
Validity area: specifying a list of frequencies (and optionally cells within that frequency). The WTRU 500 stops the measurements if it reselects to a cell that is not included in this validity area.

The validity area is optional, and the WTRU 500 is configured with at least a list of NR or a list of E-UTRA frequencies (it also can be configured with both).

Related to scheduling in NR, the base station (gNB, e.g., part of network 503), specifically the MAC entity at the gNB in an example, is responsible for the scheduling of both uplink and downlink physical resources in NR.

To make a resource efficient usage of the network's radio resources in a fair way among the different WTRUs that the network is serving, the gNB uses information, such as:
Buffer status related to the WTRU (e.g., pending data to be transmitted at the gNB in the DL for the WTRU, UL buffer status reported by the WTRU)
The QoS requirements of each WTRU and associated radio bearers
The radio conditions at the WTRU (e.g., identified through measurements made at the gNB and/or reported by the WTRU)
Power headroom at the WTRU which is the difference between the WTRU's maximum transmit power and estimated power for UL transmission (e.g., as indicated by power headroom reports from the WTRU).

The gNB will use all the above information regarding the multitude of WTRUs that it is currently serving when the gNB makes scheduling decisions in both the UL and DL (i.e., which WTRU(s) get which UL/DL resources to transmit/receive). The gNB can do the scheduling in a dynamic fashion (i.e., the WTRUs being scheduled as well as which resources are assigned to these WTRUs are changing from one radio slot/frame to another) or in a persistent way (i.e., a certain set of radio resources allocated to a WTRU or group of WTRUs in the UL or DL for a given time). Persistent scheduling in the UL in NR is referred to as configured grants whereas in the DL it is called semi-persistent scheduling (SPS).

Regarding uplink scheduling, in the uplink, the gNB can dynamically allocate resources to WTRUs via the C-RNTI on PDCCH(s). A WTRU monitors the PDCCH(s) to find possible grants for UL transmission. When CA is configured, the same C-RNTI applies to all serving cells.

The gNB may cancel a PUSCH transmission, or a repetition of a PUSCH transmission, or an SRS transmission of a WTRU for another WTRU with a latency-critical transmission. The gNB can configure WTRUs to monitor cancelled transmission indications using CI-RNTI on a PDCCH.

In addition, with configured grants, the gNB can allocate uplink resources for the initial HARQ transmissions and HARQ retransmissions to WTRUs. There are typically two types of configured uplink grants:
Type 1: RRC directly provides the configured uplink grant (including the periodicity).
Type 2: RRC defines the periodicity of the configured uplink grant while PDCCH addressed to CS-RNTI can either signal and activate the configured uplink grant, or deactivate the configured uplink grant; i.e., a PDCCH addressed to CS-RNTI indicates that the uplink grant can be implicitly reused according to the periodicity defined by RRC, until deactivated.

The WTRU may be configured with up to, for example, 12 active configured uplink grants for a given BWP of a serving cell. When more than one active uplink grant is configured, the network decides which of these configured uplink grants are active at a time (including all of them). Each configured uplink grant can either be of Type 1 or Type 2. For Type 2, activation and deactivation of configured uplink grants are independent among the serving cells. When more than one Type 2 configured grant is configured, each configured grant is activated separately using a DCI command and deactivation of Type 2 configured grants is done using a DCI command, which can either deactivate a single configured grant configuration or multiple configured grant configurations jointly.

For both dynamic grant and configured grant, for a transport block, two or more repetitions can be in one time slot, or across a time-slot boundary in consecutive available time slots with each repetition in one time slot. For both dynamic grant and configured grant Type 2, the number of repetitions also can be dynamically indicated in the L1 signaling. The dynamically indicated number of repetitions overrides the RRC configured number of repetitions, if both are present.

Regarding buffer status reporting, uplink buffer status reports (BSR) provide support for QoS-aware packet scheduling. In NR, BSR is reported at a logical channel group (LCG) granularity. A WTRU can be configured with up to 32 logical channel IDs (LCID), and these can be grouped into as many as 8 LCGs. It is noted that some special WTRUs may be configured with more than 32 LCIDs and more than 8 LCGs (e.g., the mobile termination (MT) of an integrated backhaul access (IAB) node may be configured with up to 65855 LCIDs and 256 LCGs).

A BSR can be sent in at least two formats:
A short BSR format to report the data for only one LCG;
A long BSR format to report the data from several LCGs

BSRs are transmitted using MAC Control Elements (MAC CEs). When a BSR is triggered (e.g., when new data arrives in the transmission buffers of the WTRU), if the WTRU does not have any available UL grants to send the BSR, a Scheduling Request (SR) is transmitted by the WTRU to request the needed UL resources to transmit the BSR.

There are several variants of the short and long BSR (e.g., for the case of IAB MT), but for the sake of brevity, only a subset of them are described below and are shown in the corresponding figures. Details of the variants of short and long BSR are known.

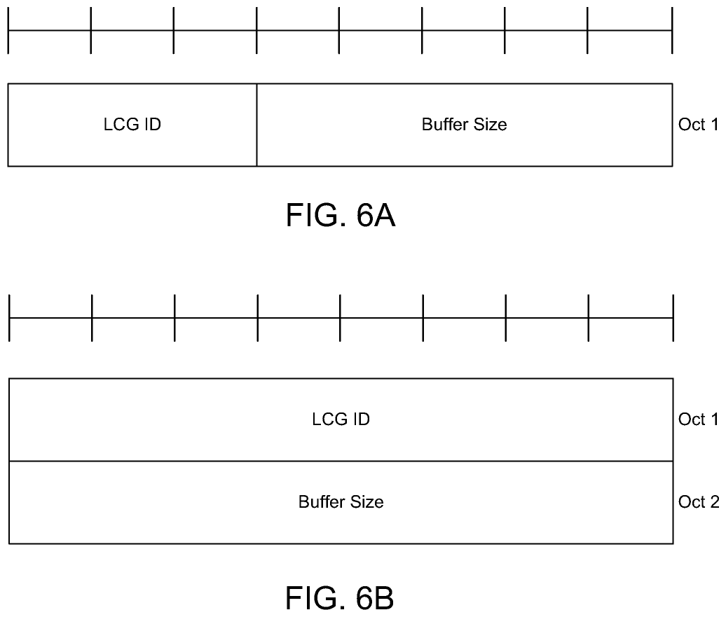

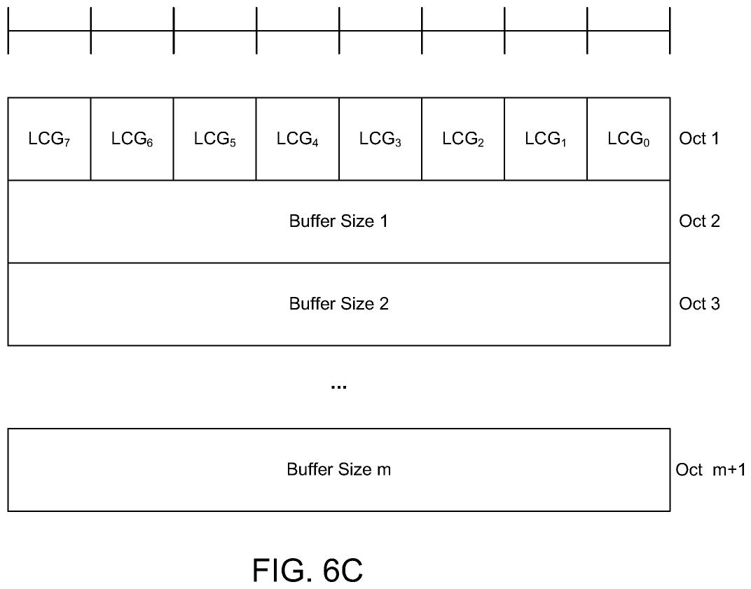

Some BSR formats are shown in FIGS. 6A-6C, where “Oct” represents 8 bits (a byte). FIG. 6A is a diagram of a Short BSR MAC CE format having one Oct, Oct1, which is sectioned into 3 bits for an LCG ID and 5 bits that indicate the size of the buffer, according to an embodiment. FIG. 6B is a diagram of an Extended Short BSR format having two Octs, October 1, which is an 8-bit LCG ID, and October 2, which is an 8-bit indicator of the size of the buffer, according to an embodiment. And FIG. 6C is a diagram of a Long BSR MAC CE format having m+1 Octs, where October 1 includes an 8-bit LCG ID, and October 2-OCT m+1 each indicates a buffer size 1-buffer size m of a respective buffer 1-buffer m, according to an embodiment.

The buffer size included in the BSR reports can be coded according to the following tables (i.e., the WTRU includes the index corresponding to the buffer size for the corresponding LCG).

| | | | | | | | |
|---|---|---|---|---|---|---|---|
| Index | BS value | Index | BS value | Index | BS value | Index | BS value |

Buffer size levels (in bytes) for 5-bit Buffer Size field

| | | | | | | | |
|---|---|---|---|---|---|---|---|
| 0 | 0 | 8 | ≤102 | 16 | ≤1446 | 24 | ≤20516 |
| 1 | ≤10 | 9 | ≤142 | 17 | ≤2014 | 25 | ≤28581 |
| 2 | ≤14 | 10 | ≤198 | 18 | ≤2806 | 26 | ≤39818 |
| 3 | ≤20 | 11 | ≤276 | 19 | ≤3909 | 27 | ≤55474 |
| 4 | ≤28 | 12 | ≤384 | 20 | ≤5446 | 28 | ≤77284 |
| 5 | ≤38 | 13 | ≤535 | 21 | ≤7587 | 29 | ≤107669 |
| 6 | ≤53 | 14 | ≤745 | 22 | ≤10570 | 30 | ≤150000 |
| 7 | ≤74 | 15 | ≤1038 | 23 | ≤14726 | 31 | >150000 |

Buffer size levels (in bytes) for 8-bit Buffer Size field

| | | | | | | | |
|---|---|---|---|---|---|---|---|
| 0 | 0 | 64 | ≤560 | 128 | ≤31342 | 192 | ≤1754595 |
| 1 | ≤10 | 65 | ≤597 | 129 | ≤33376 | 193 | ≤1868488 |
| 2 | ≤11 | 66 | ≤635 | 130 | ≤35543 | 194 | ≤1989774 |
| 3 | ≤12 | 67 | ≤677 | 131 | ≤37850 | 195 | ≤2118933 |
| 4 | ≤13 | 68 | ≤720 | 132 | ≤40307 | 196 | ≤2256475 |
| 5 | ≤14 | 69 | ≤767 | 133 | ≤42923 | 197 | ≤2402946 |
| 6 | ≤15 | 70 | ≤817 | 134 | ≤45709 | 198 | ≤2558924 |
| 7 | ≤16 | 71 | ≤870 | 135 | ≤48676 | 199 | ≤2725027 |
| 8 | ≤17 | 72 | ≤926 | 136 | ≤51836 | 200 | ≤2901912 |
| 9 | ≤18 | 73 | ≤987 | 137 | ≤55200 | 201 | ≤3090279 |
| 10 | ≤19 | 74 | ≤1051 | 138 | ≤58784 | 202 | ≤3290873 |
| 11 | ≤20 | 75 | ≤1119 | 139 | ≤62599 | 203 | ≤3504487 |
| 12 | ≤22 | 76 | ≤1191 | 140 | ≤66663 | 204 | ≤3731968 |
| 13 | ≤23 | 77 | ≤1269 | 141 | ≤70990 | 205 | ≤3974215 |
| 14 | ≤25 | 78 | ≤1351 | 142 | ≤75598 | 206 | ≤4232186 |
| 15 | ≤26 | 79 | ≤1439 | 143 | ≤80505 | 207 | ≤4506902 |
| 16 | ≤28 | 80 | ≤1532 | 144 | ≤85730 | 208 | ≤4799451 |
| 17 | ≤30 | 81 | ≤1631 | 145 | ≤91295 | 209 | ≤5110989 |
| 18 | ≤32 | 82 | ≤1737 | 146 | ≤97221 | 210 | ≤5442750 |
| 19 | ≤34 | 83 | ≤1850 | 147 | ≤103532 | 211 | ≤5796046 |
| 20 | ≤36 | 84 | ≤1970 | 148 | ≤110252 | 212 | ≤6172275 |
| 21 | ≤38 | 85 | ≤2098 | 149 | ≤117409 | 213 | ≤6572925 |
| 22 | ≤40 | 86 | ≤2234 | 150 | ≤125030 | 214 | ≤6999582 |
| 23 | ≤43 | 87 | ≤2379 | 151 | ≤133146 | 215 | ≤7453933 |
| 24 | ≤46 | 88 | ≤2533 | 152 | ≤141789 | 216 | ≤7937777 |
| 25 | ≤49 | 89 | ≤2698 | 153 | ≤150992 | 217 | ≤8453028 |
| 26 | ≤52 | 90 | ≤2873 | 154 | ≤160793 | 218 | ≤9001725 |
| 27 | ≤55 | 91 | ≤3059 | 155 | ≤171231 | 219 | ≤9586039 |
| 28 | ≤59 | 92 | ≤3258 | 156 | ≤182345 | 220 | ≤10208280 |
| 29 | ≤62 | 93 | ≤3469 | 157 | ≤194182 | 221 | ≤10870913 |
| 30 | ≤66 | 94 | ≤3694 | 158 | ≤206786 | 222 | ≤11576557 |
| 31 | ≤71 | 95 | ≤3934 | 159 | ≤220209 | 223 | ≤12328006 |
| 32 | ≤75 | 96 | ≤4189 | 160 | ≤234503 | 224 | ≤13128233 |
| 33 | ≤80 | 97 | ≤4461 | 161 | ≤249725 | 225 | ≤13980403 |
| 34 | ≤85 | 98 | ≤4751 | 162 | ≤265935 | 226 | ≤14887889 |
| 35 | ≤91 | 99 | ≤5059 | 163 | ≤283197 | 227 | ≤15854280 |
| 36 | ≤97 | 100 | ≤5387 | 164 | ≤301579 | 228 | ≤16883401 |
| 37 | ≤103 | 101 | ≤5737 | 165 | ≤321155 | 229 | ≤17979324 |
| 38 | ≤110 | 102 | ≤6109 | 166 | ≤342002 | 230 | ≤19146385 |
| 39 | ≤117 | 103 | ≤6506 | 167 | ≤364202 | 231 | ≤20389201 |
| 40 | ≤124 | 104 | ≤6928 | 168 | ≤387842 | 232 | ≤21712690 |
| 41 | ≤132 | 105 | ≤7378 | 169 | ≤413018 | 233 | ≤23122088 |
| 42 | ≤141 | 106 | ≤7857 | 170 | ≤439827 | 234 | ≤24622972 |
| 43 | ≤150 | 107 | ≤8367 | 171 | ≤468377 | 235 | ≤26221280 |
| 44 | ≤160 | 108 | ≤8910 | 172 | ≤498780 | 236 | ≤27923336 |
| 45 | ≤170 | 109 | ≤9488 | 173 | ≤531156 | 237 | ≤29735875 |
| 46 | ≤181 | 110 | ≤10104 | 174 | ≤565634 | 238 | ≤31666069 |
| 47 | ≤193 | 111 | ≤10760 | 175 | ≤602350 | 239 | ≤33721553 |
| 48 | ≤205 | 112 | ≤11458 | 176 | ≤641449 | 240 | ≤35910462 |
| 49 | ≤218 | 113 | ≤12202 | 177 | ≤683087 | 241 | ≤38241455 |
| 50 | ≤233 | 114 | ≤12994 | 178 | ≤727427 | 242 | ≤40723756 |
| 51 | ≤248 | 115 | ≤13838 | 179 | ≤774645 | 243 | ≤43367187 |
| 52 | ≤264 | 116 | ≤14736 | 180 | ≤824928 | 244 | ≤46182206 |
| 53 | ≤281 | 117 | ≤15692 | 181 | ≤878475 | 245 | ≤49179951 |
| 54 | ≤299 | 118 | ≤16711 | 182 | ≤935498 | 246 | ≤52372284 |
| 55 | ≤318 | 119 | ≤17795 | 183 | ≤996222 | 247 | ≤55771835 |
| 56 | ≤339 | 120 | ≤18951 | 184 | ≤1060888 | 248 | ≤59392055 |
| 57 | ≤361 | 121 | ≤20181 | 185 | ≤1129752 | 249 | ≤63247269 |
| 58 | ≤384 | 122 | ≤21491 | 186 | ≤1203085 | 250 | ≤67352729 |
| 59 | ≤409 | 123 | ≤22885 | 187 | ≤1281179 | 251 | ≤71724679 |
| 60 | ≤436 | 124 | ≤24371 | 188 | ≤1364342 | 252 | ≤76380419 |
| 61 | ≤464 | 125 | ≤25953 | 189 | ≤1452903 | 253 | ≤81338368 |
| 62 | ≤494 | 126 | ≤27638 | 190 | ≤1547213 | 254 | >81338368 |
| 63 | ≤526 | 127 | ≤29431 | 191 | ≤1647644 | 255 | Reserved |

In an embodiment, Radio Resource Control (RRC) configures the following parameters to control the BSR:
periodicBSR-Timer,
retxBSR-Timer,
logicalChannelSR-DelayTimerApplied;
logicalChannelSR-DelayTimer,
logicalChannelSR-Mask;
logicalChannelGroup.

The MAC entity determines the amount of UL data available for a logical channel according to the data volume calculation procedure performed at RLC and PDCP.

When performing the data volume calculation, RLC includes the RLC data PDUs that are pending transmission or retransmissions, RLC SDUs (or segments of RLC SDUs) that have not been yet included in an RLC data PDU, and any pending RLC STATUS PDU (e.g., TS 38.322)

The data-volume calculation at PDCP considers the PDCP SDUs for which PDCP data PDUs have not been constructed, PDCP data PDUs that have not yet been transmitted to lower layers, any PDCP control PDUs, and any PDPC SDUs or PDUs that are to be retransmitted due to PDCP re-establishment or PDCP data recovery as is known.

In an embodiment, a WTRU triggers a BSR if any of the following events occur:
UL data, for a logical channel which belongs to an LCG, becomes available to the MAC entity; and either
   this UL data belongs to a logical channel with higher priority than the priority of any logical channel containing available UL data which belong to any LCG; or
   none of the logical channels which belong to an LCG contains any available UL data.
in which case the BSR is referred to as ‘Regular BSR’;
UL resources are allocated and the number of padding bits is equal to or larger than the size of the Buffer Status Report MAC CE plus its subheader, in which case the BSR is referred to as ‘Padding BSR’;
retxBSR-Timer expires, and at least one of the logical channels which belong to an LCG contains UL data, in which case the BSR is also referred to as ‘Regular BSR’;
periodicBSR-Timer expires, in which case the BSR is referred to as ‘Periodic BSR’.

When Regular BSR triggering events occur for multiple logical channels simultaneously, each logical channel triggers one separate Regular BSR.

The Scheduling Request (SR) is used for requesting UL-SCH resources for new transmission.

The MAC entity may be configured with zero, one, or more SR configurations. An SR configuration includes a set of PUCCH resources for SR across different BWPs and cells. For example, at most one PUCCH resource for SR is configured per BWP.

Each SR configuration corresponds to one or more logical channels. Each logical channel may be mapped to zero or one SR configuration, which is configured by RRC. The SR configuration of the logical channel that triggered a BSR is considered as a corresponding SR configuration for the triggered SR.

In an embodiment, RRC configures the following parameters for the scheduling request procedure:
sr-ProhibitTimer (per SR configuration);
sr-TransMax (per SR configuration).

In an embodiment, the following WTRU variables are used for the scheduling request procedure:
SR_COUNTER (per SR configuration).

If an SR is triggered and there are no other SRs pending corresponding to the same SR configuration, then the MAC entity sets the SR_COUNTER of the corresponding SR configuration to 0.

When an SR is triggered, it is considered as pending until it is cancelled.

All pending SR(s) for BSR triggered according to the BSR procedure prior to the MAC PDU assembly are cancelled and each respective sr-ProhibitTimer is stopped when the MAC PDU is transmitted and this PDU includes a Long or Short BSR MAC CE, which contains buffer status up to (and including) the last event that triggered a BSR prior to the MAC PDU assembly. All pending SR(s) for BSR triggered according to the BSR procedure are cancelled and each respective sr-ProhibitTimer is stopped when the UL grant(s) can accommodate all pending data available for transmission.

Only PUCCH resources on a BWP that is active at the time of SR transmission occasion are considered valid.

Regarding BSR, 3GPP designers have started investigating the utilization of AI/ML mechanisms for improved, even optimized, operation of the radio access network (RAN). For example, several use cases have been identified, such as:
network energy saving; load balancing; and mobility optimization.

AI/ML models are proposed to be used by the network and/or WTRU to predict different aspects such as WTRU trajectory, WTRU traffic, serving and neighbor cell signal levels, etc. And based on these predictions, the network could make better and proactive decisions instead of the legacy way of operating in a reactive manner (e.g., handover when the signal level of a neighbor cell becomes better than the serving cell, traffic steering/load balancing once the serving cell becomes overloaded).

The predictions can be made by the network, the WTRU, or a collaboration between the two. For example, in the area related to traffic prediction, the WTRU can be provided with an AI/ML model (e.g., provided by the network, proprietary model by the WTRU vendor or operator), and once that model is well trained (e.g., for a certain period of time until the WTRU has verified the predictions are with a certain level of acceptable accuracy or error margin), the WTRU can be configured to send predictive BSRs even before actual traffic has arrived at the WTRU buffers, giving the network a lead time, and enabling it to make better decisions (e.g., giving more configured/dynamic grants, configuring additional carriers or/and dual connectivity, offloading the concerned WTRU or other WTRU to neighboring cells preemptively), so that resources will be available to that WTRU by the time that the predicted data is actually available and ready to be sent at the WTRU buffers.

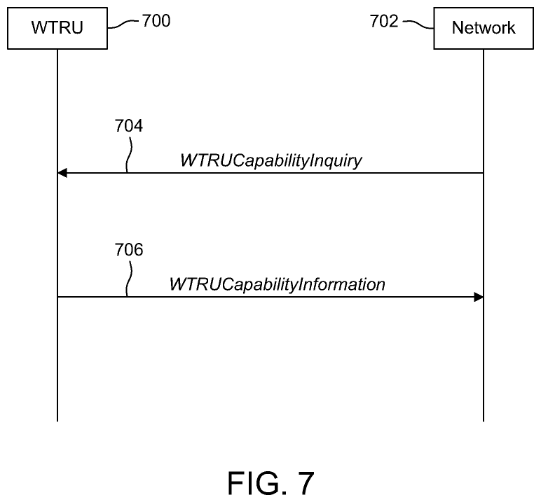

Regarding WTRU transfer, as shown in FIG. 7, in NR, a WTRU 700 compiles and transfers its WTRU capability information upon receiving a WTRUCapabilityInquiry message from a network 702 at 704 by sending a UECapabilityInformation message to the network at 706.

The network 702 initiates the procedure to the WTRU 700 in the RRC_CONNECTED mode when the WTRU needs (additional) WTRU radio access capability information. The network 702 retrieves WTRU 700 capabilities after AS security activation. The network does not forward, to a CN, WTRU 700 capabilities that were retrieved before AS security activation.

The WTRU 700 capability may be requested per Radio Access Technology (RAT) type (e.g., NR, E-UTRA). Additional filters also can be included in the capability request to limit the UL signalling as the size of all the WTRU capability information can be substantial and the network 702 may already have some of the WTRU's capability information (e.g., from earlier capability transfer from the WTRU 700 or, from earlier capability transfer from the CN).

As discussed below, a WTRU 700 can be configured to perform measurements while it is in an RRC_IDLE or RRC_INACTIVE mode, and it can provide these measurements as soon as it transitions to a CONNECTED mode (e.g., due to the reception of a paging indicating DL data arrival or detecting UL data arrival).

Based on these measurements, the network 702 can configure the WTRU 700 with CA or/and DC. However, such mechanisms just consider the availability of carriers for configuring the WTRU 700 with a CA or/and DC. Therefore, a WTRU 700 may end up being configured with a CA or/and DC but may not take advantage of this configuration (e.g., the WTRU will have only limited UL/DL data to send/receive for a considerable time after the CA/DC is configured). Of course, the network 702 could be able to detect that and release the CA or/and DC configurations. However, during this time, resources that have been provisioned for this WTRU 700 may not be available to other WTRUs. Also, there may be an unnecessary signaling to configure and then release the CA or/DC.

A potential problem with current mechanisms for early measurement configuration is that reporting and CA/DC configuration based on the current mechanisms do not consider the need of the WTRU for CA/DC.

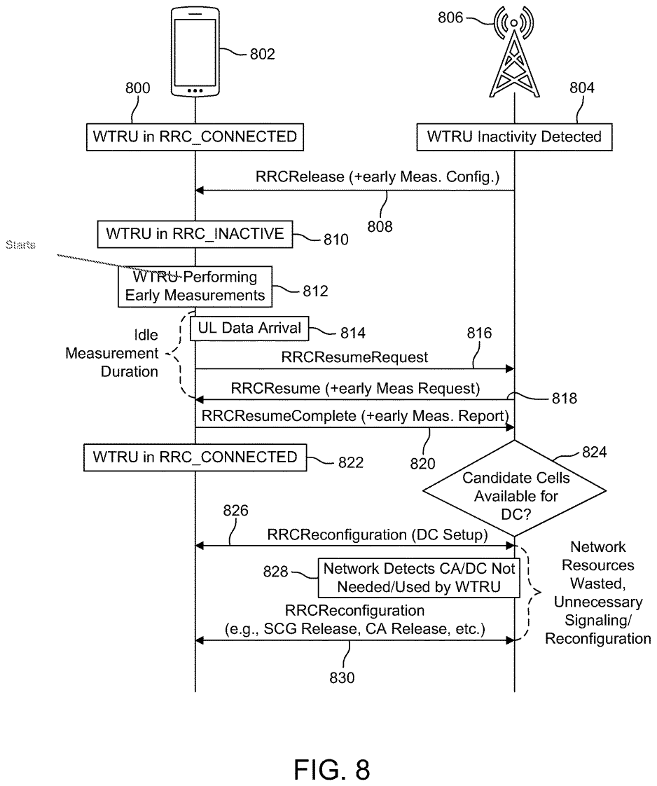

Referring to FIG. 8, at 800, a WTRU 802 is in a RRC-CONNECTED Mode.

At 804, a network 806 detects that the WTRU 802 is exhibiting no activity, and at 808 the network sends a RRCRelease message, along with one or more early-measurement configurations, to the WTRU.

At 810, the WTRU 802 enters and is in, an RRC-INACTIVE Mode, and at 812, the WTRU starts performing, and performs, one or more early measurements regarding, e.g., parameters of a UL or a DL such as data size, data throughput, number of carriers, or QoS of the channel(s) over which the UL or DL is transmitted or received. The WTRU continues to perform the one or more early measurements throughout an idle-measurement duration 815.

At 814, while the WTRU 802 is taking early measurements in the RRC-INACTIVE mode, UL data arrives for the WTRU to transmit to the network 806.

At 816, the WTRU 802 sends an RRCResumeRequest to the network 806, and, at 818, the network sends, to the WTRU, an RRCResume message along with a request for the one or more early measurements taken by the WTRU during and after 812.

At 820, the WTRU 802 sends, to the network 806, an RRCResumeComplete message along with a report of the one or more early measurements taken by the WTRU during and after 812.

At 822, the WTRU 802, while in the RRC-CONNECTED Mode, transmits the uplink data to the network 806.

At 824, the network 806 determines whether there are available candidate cells for the WTRU 802 to operate in a Dual-Connectivity (DC) mode.

At 826, the network 806 sends, to the WTRU 802, an RRCReconfiguation message that includes, e.g., a DC setup configuration, and the WTRU configures itself to operate in a DC mode (or in a CA/DC mode).

At 828, the network 806 detects that the WTRU 802 need not operate in either a Cellular-Automation (CA) mode or in a Dual-Connectivity (DC) mode because, e.g., the UL/DL load, or other parameters of the data transfer such as number of available carriers and QoS, are suitable for the WTRU to operate in a mode other than a CA mode, a DC mode, and/or a CA/DC mode. The WTRU 802 operating in a CA/DC mode when it is unnecessary to do so can waste one or more resources of the network 806 during an interval 829.

And at 830, the network 806 sends, to the WTRU 802, an RRCReconfiguration message that includes, e.g., an SCG release and/or a CA release, and the WTRU reconfigures itself to operate in a single-cell mode or another mode other than a DC mode (and/or a CA mode and/or a CA/DC mode).

Another issue regarding the validity of these early measurements, as discussed below, is that the early measurement configuration has an associated idle-measurement duration/time, and a WTRU performs the measurements only for this duration after transitioning to the IDLE/INACTIVE mode. For example, if the measurement duration was 10 sec, and the WTRU has been in the IDLE/INACTIVE mode for 30 sec, then the measurements that it has will be 20 sec old. And these measurements may be completely different from the current situation at the WTRU. For example, cells that were measured as strong may be very weak by the time that the WTRU becomes active, or the WTRU may even be out of the coverage of such a cell. Thus, if the network uses the early measurement reported during the setup/resume to configure CA or/and DC, some failure could happen (e.g., radio-link failure on the SCG, which the WTRU typically is required to report, and the network has to reconfigure itself or the WTRU again).

Another potential problem of current mechanisms for early-measurement configuration is that reporting and CA/DC configuration based on such early measurement(s) may lead to the wrong configuration of CA/DC due to outdated measurement results.

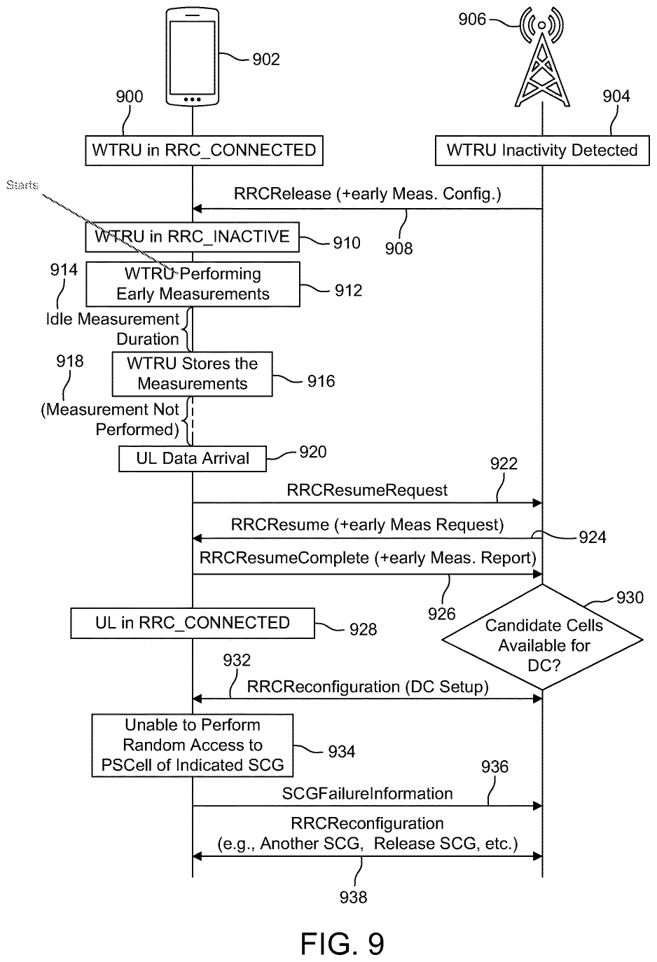

Referring to FIG. 9, at 900, a WTRU 902 is in a RRC-CONNECTED Mode.

At 904, a network 906 detects that the WTRU 902 is exhibiting no activity, and at 908 the network sends an RRCRelease message, along with one or more early-measurement configurations, to the WTRU.

At 910, the WTRU 902 enters and is in, an RRC-INACTIVE Mode, and at 912, the WTRU starts performing, and performs, early measurements regarding, e.g., parameters of a UL or a DL such as data size, data throughput, number of carriers, or QoS of/for the channel(s) over which the UL or DL is transmitted or received.

During an interval 914, the WTRU 902 takes early measurements while in an IDLE/INACTIVE Mode.

At 916, the WTRU 902 stores the early measurements (i.e., stores the results of the performed early measurements) in onboard memory.

During an interval 918, the WTRU 902 takes no early measurements.

At 920, UL data arrives for the WTRU 902 to transmit to the network 906 or elsewhere.

At 922, the WTRU 902 sends an RRCResumeRequest to the network 906, and, at 924, the network sends, to the WTRU, an RRCResume message along with a request for the one or more early measurements taken by the WTRU at 912 and 914.

At 926, the WTRU 802 sends, to the network 906, an RRCResumeComplete message along with a report of the early measurements taken by the WTRU at 912 and 914.

At 928, the WTRU 902, while in the RRC-CONNECTED Mode, transmits the uplink data to the network 906.

At 930, the network 906 determines whether there are available candidate cells for the WTRU 902 to operate in a Dual-Connectivity (DC) mode.

At 932, the network 906 sends, to the WTRU 902, an RRCReconfiguation message that includes, e.g., a DC setup configuration, and the WTRU configures itself to operate in a DC mode (or in a CA/DC mode) accordingly.

At 934, the WTRU 902 determines that it cannot access (e.g., is unable to perform a Random Access) the primary cell (PSCell) of the secondary group of cells (SCG).

At 936, the WTRU 902 notifies the network 906 of this access inability by sending an SCGFailureInformation message to the network.

And at 938, the network 906 sends, to the WTRU 902, an RRCReconfiguation message that includes, e.g., one or more other SCG identifiers and an SCG release (to release the WTRU from the current SCG having the PSCell that the WTRU cannot access), and the WTRU configures itself to operate in a DC mode (or in a CA/DC mode) with another SCG accordingly.

One or more embodiments, such as the foregoing embodiments, disclosed herein can address potential problems and issues described above and elsewhere herein.

The terms “early measurements”, “idle-mode measurement”, “idle measurements”, and “idle/inactive measurements” are used interchangeably to refer to measurements performed by a WTRU while it is in the RRC_IDLE or RRC_INACTIVE mode.

In this disclosure, the terms “mode” and “state” are used interchangeably (e.g., IDLE mode and IDLE state).

In this disclosure, the terms “data volume/type” and “traffic volume/type” are used interchangeably.

In this disclosure, the terms “connection setup” and “connection establishment” are used interchangeably.

The term AI/ML (Artificial Intelligence/Machine Learning) is used to describe any model and associated learning algorithm used by a WTRU (e.g., a UE) and/or network to predict future behavior (e.g., in this disclosure, the behavior of data arrival rate/volume at the WTRU to be sent to the network, or from the network to the WTRU). The model and associated learning algorithm are assumed to utilize a big set of data collected by the WTRUs currently or previously connected to the network and/or network. The details about the model and the associated learning algorithm are outside the scope of this disclosure. However, it can be assumed that the AI/ML mode is making the predictions based on several conditions such as current time, current WTRU location, WTRU mobility pattern, etc. For example, the AI/ML model may be able to predict future UL/DL data arrival based on current and/or historical measurements of UL/DL data arrival/volume (e.g., considering the UL/DL data arrival rates/volumes at a similar time of day and/or at a similar location as the current time/location, or considering the current active bearers/applications).

At least some embodiments described in this disclosure are agnostic/independent to the AI/ML model/technique that is being used (e.g., the algorithm used, the mechanism such as neural network or what kind of neural network, e.g., depth and parameters/weights of the network). However, it can be assumed that a WTRU has a pre-trained AI/ML model that can produce predictions of UL/DL data arrival rate/volume. For example, the model can be provided to the WTRU by a network (e.g., a mobile network) to which the WTRU is registered or seeks registration, or the model can be loaded into memory of the WTRU by the WTRU manufacturer or other provider.

In an embodiment, the predictions can be done for one point in time only (e.g., model produces the expected UL/DL data arrival rate/volume X milliseconds (ms) from the present time) or can extend over several time steps (e.g., a time series of predictions for the next Y ms, at every X ms interval).

As disclosed above, the AI/ML model at the WTRU may be implementation based (e.g., installed/provided by the WTRU vendor) or the WTRU may obtain the AI/ML model from the network (NW).

For any predicted value, the predicted value itself may be associated and/or represented by a confidence or error-margin value, and may be represented by an average, peak, minimum value, etc. along a short time window representing the validity of that prediction.

Furthermore, the following is assumed:
there is some WTRU capability communication between the WTRU and the network about AI/ML capability (e.g., where the WTRU can indicate to the network the supported AI/ML models/functions, confidence level of predictions, e.g., time horizon of predictions (how far along in the future are the prediction being made));
the WTRU may support several AI/ML models for a certain functionality (e.g., with different prediction time horizons, prediction confidence levels, processing requirements, trained under/for operation in different cells/location/times of day/application types);
a given AI/ML model can operate in different modes (e.g., with different levels of prediction confidence levels at different prediction time horizons);
the WTRU may choose the AI/ML model to use for a certain functionality (e.g., network decides for which functionalities the WTRU can use AI/ML based operation, and the WTRU chooses the AI/ML model to use) or the network may explicitly control this (e.g., WTRU provides details of one or more AI/ML models and their capabilities, network determines which of the one or more models to activate for a particular functionality);
the AI/ML models can be available at the WTRU already trained, or the WTRU may be provided with an untrained AI/ML model and performs the training by itself;
The AI/ML model is available at the WTRU already trained, and the WTRU may be enabled/configured to perform further training (e.g., for different conditions such as cells/location/times of day, for conditions different from the initial training, for conditions the same as the initial training but for increasing the level of confidence and/or the prediction time horizon);
In the case of a time series of output, the prediction confidence may be variable from one output to the other (e.g., higher confidence level for predictions that are X ms away as compared to predictions Y ms away, where Y>X);
the prediction confidence level can be in percentage confidence (e.g., expected likelihood of this prediction will come true), in terms of error margin (e.g., in Y ms, the predicted UL data rate is expected to be between X− (lower_error_margin) and X+ (upper_error_margin)), or both in confidence percentage and error margin (e.g., in Z ms, the predicted UL data rate is expected to be between X− (lower-error_margin) and X+ (upper_error_magin), with a confidence of 90%); and/or
for a given time horizon of prediction, there could be different ranges of predicted values with different confidence levels or error margins (e.g., in Y ms, the predicted UL data rate is expected to be between

$$X 1 - ( lower\_error \_margin 1 ) and X 1 + ( upper\_error \_margin 1 ) ,$$

$$with a confidence of 95 \% ,$$

$$between X 2 - ( lower\_error \_margin 2 ) and X 2 + ( upper\_error \_margin 2 ) ,$$

$$with a confidence of 85 \% ) .$$

In this disclosure, the terms “expected”, “anticipated”, “estimated”, “predictive” and “predicted” (and their adverb variants) are used interchangeably.

In this disclosure, the term “time horizon” is used to refer to the time (i.e., delta time from the current time) at which the predicted UL data is expected to arrive (i.e., ready to be sent) by the WTRU.

And, in this disclosure, the term “normal BSR” is used to describe legacy BSR reporting (e.g., up until NR rel-17) that is triggered when UL data actually arrives at the WTRU (e.g., regular BSR, padding BSR, periodic BSR).

In an embodiment, a WTRU is configured to start performing early measurements while in an IDLE/INACTIVE mode based on predicted UL data arrival.

In an embodiment, the WRTU may be configured to perform measurements while in an IDLE mode or INACTIVE mode, but the WRTU starts performing the measurements only when it predicts UL data is expected to arrive within a given configured time. This can be further constrained by a configured accuracy level (or error range) of the prediction. For example, the WTRU may be configured to start performing the measurements only if UL data is expected to arrive within x ms, at an accuracy level of ≥90% (or error level of ≤+y Kbits). In an embodiment, the accuracy level may be configured and/or determined in terms of confidence level associated with prediction of an AIML model.

In an embodiment, the WTRU may be configured to perform measurements while in an IDLE or INACTIVE mode, but the WTRU starts performing the measurements only when it predicts a certain volume of UL data is expected to arrive within a given configured time. This can be further constrained by a configured accuracy level (or error range) of the prediction. For example, the WTRU may be configured to start performing the measurements only if UL data of at least A kbits is expected to arrive within x ms, at an accuracy level of ≥90% (or error level of ≤+y Kbits).

In a variant of the above-described embodiment, a further granular configuration can be provided to the WTRU where the volume of UL data is specific to a certain type(s) of traffic. For example, if the WTRU is in an INACTIVE state or mode, the traffic volume can be associated with one of the LCIDs or the bearer IDs of the saved WTRU context. As another example, the traffic volume could be associated with a certain QoS level of the traffic, for example, in terms of latency, bit rate, etc. As another example, the traffic volume could be associated with a certain application type (e.g., web browsing, streaming service). Different traffic volume levels for different types of traffic could also be specified. The traffic volume for a certain type of data (e.g., LCID, bearer ID, QoS level, application type) could be set to a very low value, e.g., 0, to indicate to the WTRU to start performing measurements if any level of UL data is expected for such traffic type.

In an embodiment, the WTRU may be configured to keep performing the measurements that it has started based on any of the above conditions until the configured idle measurement duration has expired.

In an embodiment, the WTRU may be configured to keep performing the measurements that it has started based on any of the above conditions as long as the UL prediction is still fulfilled. For example, if at time t1, the WTRU has started the measurements and at time t2 the prediction now indicates otherwise (e.g., predicted UL data now is below the configured threshold), the WTRU may stop performing the measurements.

In an embodiment, the same configuration/behavior is applied for IDLE and INACTIVE modes.

In an embodiment, the configuration/behavior that is applied for IDLE and INACTIVE modes is different (e.g., different parameters such as thresholds specified for IDLE and INACTIVE modes).

In an embodiment, the same configuration/behavior is applied for all frequencies being measured (i.e., both NR and E-UTRA frequencies).

In an embodiment, different configuration/behavior is applied for NR and E-UTRA frequencies. For example, different parameters such as thresholds are configured for NR and E-UTRA frequencies.

In an embodiment, the WTRU may be configured to apply different configuration/behavior even for different sets of frequencies within NR and or E-UTRA. For example, different parameters such as thresholds can be specified for NR FR1 frequencies and NR FR2 frequencies.

In an embodiment, the WTRU may be configured to apply different configuration/behavior for different sets of cells (either intra-frequency or inter-frequency or inter-RAT). For example, the WTRU may be configured with different sets of cells to measure, each associated with different parameters such as thresholds.

In an embodiment, the WTRU may be configured to apply legacy configuration/behavior for certain frequencies of a given RAT (i.e., do not consider UL data prediction), while being configured to apply a UL data prediction-based approach based on any of the embodiments above for other frequencies of a given RAT. For example, the WRTU may be configured to apply legacy configuration/behavior for NR FR1 frequencies but to apply UL data prediction-based approach for NR FR2 frequencies.

In an embodiment, the WTRU may be configured to apply a UL data prediction-based approach for a first group of preconfigured LCIDs and apply legacy configuration/behavior for a second group of LCIDs. For example, the second group of LCIDs may be associated with services whose arrival patterns are hard to predict or UL-prediction based approaches are not desirable. For example, the WTRU may be configured to perform measurements when the conditions are satisfied for either a first group of LCIDs or a second group of LCIDs. For example, the conditions for a second group of LCIDs may be associated with transition to an IDLE/INACTIVE mode and the measurements are performed for a duration corresponding to idle-measurement-duration configuration or expiry timer.

In an embodiment, the WTRU may be configured to start the UL data-arrival prediction upon a preconfigured condition. For example, the WTRU may be configured to perform legacy early measurements for a duration corresponding to an idle-measurement duration and/or until a timer expires. The WTRU may be configured to store the results of measurements performed during this initial idle-measurement duration (herein referred to as initial idle-measurement results). Upon expiry of the timer, the WTRU may start UL data-arrival prediction. Based on the result of UL data-arrival prediction, the WTRU may then perform the measurements during the subsequent idle-measurement duration (herein referred to as subsequent idle-measurement results). The WTRU may be configured to store the results of subsequent measurement duration separately from the initial idle-measurement duration.

In an embodiment, the WTRU may be configured to perform prediction of one or more measurements results for a future time.

In an embodiment, the WTRU may be configured to transmit the results of measurements made based on the UL and/or DL data prediction in an RRC message. For example, in an RRC resume request, an RRC resume complete, an RRC connection request, an RRC setup request, an RRC setup complete, an RRC reconfiguration complete, WTRU assistance information, etc. In an embodiment, the WTRU may be configured to perform both legacy early measurements and idle measurements based on data-arrival prediction. In an embodiment, the WTRU may transmit results of both measurements performed during an initial idle-measurement duration and subsequent idle-measurement duration. In such case, the WTRU may indicate explicitly or implicitly the type of measurement results, e.g., initial idle-measurement results and/or subsequent idle-measurement results are included in the RRC message.

In an embodiment, the WTRU at a current time T may be configured to perform prediction of measurements associated with a future time T+n. The time units may be expressed as offset in terms of symbols, number of slots, subframes, radio frames or number of milliseconds. Possibly the WTRU may use reference signals received at time T and optionally one or more historical measurements (e.g., obtained at time t<T) to determine the measurement results for future time T+n. Possibly the WTRU may start the measurement prediction based one or more criteria defined herein associated with UL/DL data-arrival prediction. In an embodiment, the WTRU may be configured to transmit the results of predicted measurements to the network in an RRC message. For example, in an RRC resume request, an RRC resume complete, an RRC connection request, an RRC setup request, an RRC setup complete, an RRC reconfiguration complete, WTRU assistance information, etc. In an embodiment, the WRTU may be configured to perform measurement prediction during an initial idle-measurement duration. In an embodiment, the WTRU may be configured to perform measurement prediction during a subsequent idle-measurement duration. Such measurement prediction may be alternative to or in addition to the direct measurements performed during idle- and/or subsequent-measurement duration. The WTRU may be configured to include the measurement results based on direct measurement (e.g., based on reference-signal measurement or a value derived thereof) and/or based on predicted measurement (e.g., based on an AIML model) in an RRC message while or after transition to a CONNECTED mode.

In an embodiment, a WTRU may trigger a random-access procedure to initiate an RRC connection or an RRC resume procedure. The WTRU may be configured to include the results of predicted measurements in one or more of the RRC messages (RRC resume request, RRC resume complete, RRC connection request, RRC setup request, RRC setup complete, RRC reconfiguration complete, WTRU assistance information, etc.). For example, the WTRU may initiate a random-access procedure at time T. The WTRU may send a connection request or resume request at time T+m. The WTRU may be configured to perform initial and/or subsequent idle measurements during time T−x (where x>0). In an embodiment, the WTRU may be configured to predict measurement results at future time T−y (where 0<y<x) based on reference signals received at time T−x and/or earlier. The WTRU can include the measurement results associated with time T−y in the RRC message sent at T+m. In an embodiment, the WTRU, after initiating a random-access procedure at time T, may continue performing measurement predictions applicable for time T+n (where n>0, possibly even n>m) using the reference signals received until T+m or earlier. The WTRU may be configured to include the predicted measurement results associated with time T+n in the RRC message. The WTRU may be configured to include both the direct-measurement results and predicted-measurement results in the RRC message. The WTRU may explicitly or implicitly indicate that the measurement results are based on prediction. The WTRU may also indicate at what time the predicted measurement results should be assumed to be applicable (e.g., T−y or T+n). Optionally, the WTRU also may include an accuracy level or confidence level associated with the prediction. In an embodiment, the values x, y, n, and m may be based on WTRU capability and may be indicated to the network by the WTRU. In an embodiment, the values of x, y, n, and m may be configured by the network considering the WTRU capability.

In an embodiment, the WTRU may be configured to apply legacy configuration/behavior for a certain set of cells (either intra-frequency, inter-frequency, or inter-RAT) (i.e., do not consider UL data prediction), while applying a UL data-prediction-based approach based on any of the embodiments above (or otherwise herein) for other sets of cells.

The WTRU may be configured to stop performing early measurements while in an IDLE/INACTIVE mode based on predicted UL data arrival.

In an embodiment, the WTRU may be configured to start performing the measurements while in an IDLE or INACTIVE mode as in legacy (i.e., immediately, or almost immediately, after transitioning to an IDLE/INACTIVE mode), but the WTRU may stop performing the measurements, even before the configured idle-measurement duration has expired, if the WTRU predicts that no UL data (or UL data above a certain volume) is expected to arrive within a given time. This can be further constrained by a configured accuracy level (or error range) of the prediction. For example, assume the WTRU is configured with an idle-measurement duration of 10 seconds and starts performing the measurements immediately after going to an IDLE/INACTIVE mode. Five seconds after that, if the WTRU determines that there will be no UL data within the next 5 seconds, within the configured accuracy (e.g., 90%), then the WTRU may stop performing the measurements.

In a variant of an above embodiment, a further granular configuration can be provided to the WTRU where the UL data prediction is concerning a certain type(s) of traffic (e.g., LCID, bearer ID, QoS level, application type). For example, the WTRU could be configured to stop the measurements based only on UL data prediction of streaming applications/bearers.

In an embodiment, the same configuration/behavior is applied for IDLE and INACTIVE modes

In an embodiment, the configuration/behavior that is applied for IDLE and INACTIVE modes is different (e.g., different parameters such as thresholds specified for IDLE and INACTIVE modes).

In an embodiment, the same configuration/behavior is applied for all frequencies being measured (i.e., both NR and E-UTRA frequencies).

In an embodiment, different configuration/behavior is applied for NR and E-UTRA frequencies. For example, different parameters such as thresholds are configured for NR and E-UTRA frequencies.

In an embodiment, the WTRU may be configured to apply different configuration/behavior even for different sets of frequencies within NR and or E-UTRA.

In an embodiment, the WTRU may be configured to apply different configuration/behavior for different sets of cells (e.g., either intra-frequency or inter-frequency or inter-RAT).

In an embodiment, the WTRU may be configured to apply legacy configuration/behavior for certain frequencies of a given RAT (i.e., do not consider UL data prediction), while applying a UL data-prediction-based approach based on any of the solutions above for stopping the measurements of other frequencies of a given RAT.

In an embodiment, the WTRU may be configured to apply legacy configuration/behavior for certain sets of cells (either intra-frequency, inter-frequency, or inter-RAT) (i.e., do not consider UL data prediction to stop the measurements), while applying a UL data-prediction-based approach based on any of the embodiments above (or otherwise herein) for other sets of cells.

A WTRU can be configured to start/stop measurements based on UL data prediction provided to the WTRU by the network.

In the above-described embodiments, however, it is assumed that the WTRU behavior on performing IDLE/INACTIVE measurements is based on UL data prediction performed by the WTRU itself.

In an embodiment, the UL data prediction is performed by the network, and the network sends an indication to the WTRU regarding this UL data prediction. For example, the WTRU may receive a paging from the network (e.g., CN paging while in an IDLE mode, RAN paging while in an INACTIVE mode) that includes information about the UL prediction performed by the network (e.g., whether there will be UL data within a given time horizon, the accuracy or error level of the prediction, and/or anticipated traffic level). The WTRU then could apply similar behavior to the behaviors discussed above based on these predictions.

In an embodiment, the UL data prediction is performed by both the network and the WTRU, and the WTRU may make the decision based on either or both of these predictions, for example:
WTRU predictions take precedence
Network predictions take precedence
the WTRU considers both predictions independently (e.g., start the measurements based on the WTRU predictions or the provided network predictions)
the WTRU combines the two predictions (e.g., if a network predicts x Mbs of UL data, the WTRU predicts y Mbs of data, the WTRU will assume (x+y)/2 Mbs of data, as another example, the WTRU may be predicting one traffic type and the network predicting another traffic type and the WTRU has different thresholds associated with the different traffic types and thus will consider both)
the WTRU takes the prediction with the highest accuracy or/and lowest error level
Other examples are contemplated.

In an embodiment, instead of the network indicating UL data-prediction information to the WTRU, the network can simply command the WTRU to stop/(re) start the idle/inactive measurements, e.g., via a paging-like message.

The WTRU can be configured to start/stop measurements based on DL data prediction.

In the above embodiments, it is assumed that the WTRU behavior on performing IDLE/INACTIVE measurements is based on UL data prediction (either performed by the WTRU itself or provided by the network, e.g., via a paging-like message).

In an embodiment, the WTRU also may be capable of predicting DL data traffic and may be configured to apply, to DL data traffic and DL data-traffic prediction, behavior similar to that described above for embodiments that are based on the UL data prediction.

In an embodiment, the DL data prediction is performed by the network and provided to the WTRU (e.g. in a paging like message). This indication from the network may include information such as whether there will be DL data within a given time horizon, the accuracy or error level of the prediction, anticipated traffic level, etc.

There are embodiments directed to how the WTRU configuration is performed.

In an embodiment, the WTRU is configured with the parameters/behaviors discussed for any of the embodiments above while it is in a CONNCETED mode (e.g., in an RRC reconfiguration message).

In an embodiment, the WTRU is configured with the parameters/behaviors discussed for any of the embodiments above during the transition to IDLE/INACTIVE mode (e.g., in the RRCRelease message).

In an embodiment, the WTRU is configured with the parameters/behaviors discussed for any of the embodiments above using broadcast information (e.g., SIB).

A combination of all of the above is possible (e.g., some part of the configuration provided in an RRCReconfiguration message while the WTRU is in CONNECTED, a delta configuration on top of that provided in an RRCRelease message, and/or the WTRU updating the configuration based on the SIB of a target cell when it performs cell re-selection).

In an embodiment, the WTRU may indicate its data-prediction capabilities to the network while the WTRU is in CONNECTED mode. This may include information such as prediction time horizon(s), confidence/accuracy/error levels, granularity of predictions, etc.

In an embodiment, the WTRU may be configured by the network on a particular prediction capability (or capabilities) to be used (e.g., if the WTRU has multiple capabilities of making predictions, each with different time horizon values and accuracy level, the network may indicate to the WTRU which of this capability or capabilities to be used).

In an embodiment, the WTRU is configured to indicate to the network (e.g., in an RRC Resume Complete message) the reason that the WTRU is not including a measurement report as part of, or otherwise in conjunction with, the message even if the network has indicated a request in the RRC Resume message). This indication could indicate to the network information such as:
Current and/or predicted UL/DL traffic volume is not big enough (e.g., is below a certain threshold)
Current and/or predicted UL/DL traffic type does not require CA/DC (e.g., best-effort traffic).

In an embodiment, the WTRU may include additional information related to the measurement report it is sending (e.g., in the RRC Resume Complete message, either in the measurement report included in the message or in an information element separate from the RRC Resume Complete message) such as time information related to the early measurements (e.g., elapsed time since the measurement was taken, timestamp when the WTRU started to perform the measurements).

In an embodiment, the WTRU sends the current and/or predicted BSR to the network during the connection setup or resume (e.g., in a BSR MAC CE multiplexed with msg3 or msg5, in a new IE(s) in the RRC Resume Complete message).

In an embodiment, the WTRU may perform the measurements regardless of the determination of the need for the upcoming UL/DL traffic. However, the WTRU may include indication information such as whether CA and/or DC configuration is desirable, or the predicted/current BSR (e.g., using any of the embodiments discussed above or otherwise herein).

In an embodiment, the predicted BSR sent by the WTRU during the resume/setup procedure may include more detailed information such as predicted traffic patterns for a longer duration.

In an embodiment, instead of the network indicating UL or/and DL data-prediction information to the WTRU, the network simply can command the WTRU to stop/(re) start the idle/inactive measurements, e.g., via a paging-like message.

In an embodiment, the WTRU may be capable of both UL and DL traffic prediction (or provided with either or both UL/DL data prediction from the network), and maybe configured to apply similar behavior to the above solutions by considering either of the UL or the DL prediction or a combination of them, for example:
UL predictions take precedence (i.e., measurement decisions based on UL prediction only)
DL predictions take precedence
The WTRU may be configured with different parameters/thresholds for UL and DL traffic and apply the corresponding behavior independently
The WTRU takes the UL or DL prediction into consideration, depending on which has the highest accuracy or/and lowest error level
Other examples are contemplated.

In an embodiment, the behavior to start/stop can be applied several times, depending on the conditions. For example, the WTRU may have stopped the measurements based on a prediction performed at time t1, and if later at time t2, a prediction indicates otherwise (e.g., there will be UL data), the WTRU may re-start the measurements.

In an embodiment, the WTRU keeps (e.g., stores in memory onboard the WTRU) the measurement results it has performed, even after it has stopped the measurements.

In an embodiment, the WTRU deletes the measurement results it has performed when it stops the measurements.

In an embodiment, the WTRU may be configured with a certain validity duration, indicating for how long the WTRU can keep the measurements stored after it has stopped performing the measurements.

In an embodiment, the WTRU may be configured to tag the measurements that it is storing/keeping with timing information (e.g., each measurement sample is associated with a timestamp, a certain set of measurements can be tagged with time durations, e.g., between timestamp t1 and timestamp t2 or start timestamp and duration).

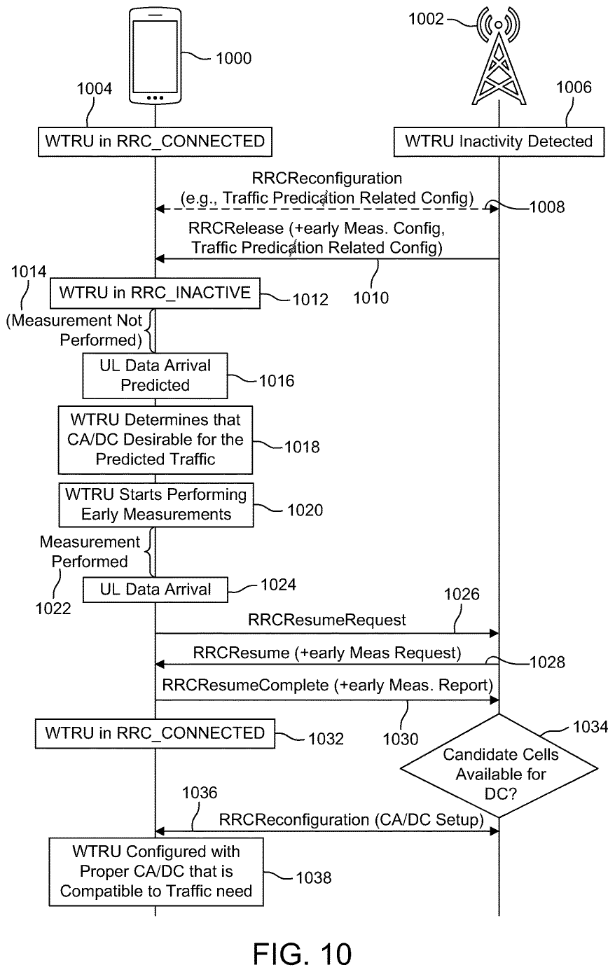

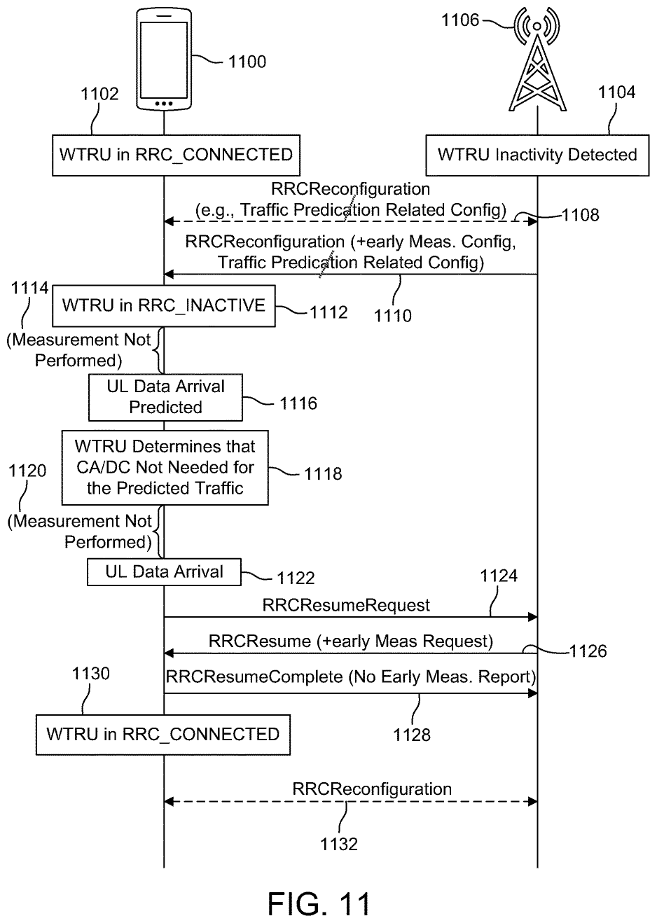

FIGS. 10-11 illustrate some features of the embodiments disclosed above.

In an embodiment, according to the diagram of FIG. 10, a WTRU 1000 is provided with the configurations (while in the CONNECTED mode or upon transitioning to the INACTIVE mode) related to an early measurement configuration that is dependent on traffic prediction, according to an embodiment. The WTRU 1000 will not start performing the measurement(s) until the WTRU has predicted that UL data is predicted to arrive, and that CA/DC setup is desirable (e.g., a high volume of data is expected, data belongs to a service that requires high reliability where duplication via CA or DC is required). When the UL data arrives, the WTRU 1000 will send the RRCResumeRequest message to a network 1002, and will send a more up-to-date measurements indicating CA/DC candidate cells in the RRCResumeComplete message. If there are suitable cells for CA/DC, the network 1002 will configure the WTRU to use those cells.

Referring to FIG. 10, at 1004, the WTRU 1002 is in an RRC-CONNECTED Mode.

At 1006, the network 1002 detects that the WTRU 1000 is exhibiting no activity, and at 1008, the network sends, to the WTRU, an RRCReconfiguation message that includes, e.g., a traffic-prediction-related configuration, and the WTRU configures itself to operate according to one or more of the configurations.

Alternatively, at 1010, the network 1002 sends, to the WTRU 1000, an RRCRelease message, along with one or more early-measurement configurations and traffic-prediction-related configurations, and the WTRU configures itself to operate according to one or more of the configurations.

At 1012, the WTRU 1000 enters, and is in, an RRC-INACTIVE Mode, and performs no early measurements during an interval 1014.

At 1016, the WTRU 1000 predicts that UL data having suitable prediction and data parameters (e.g., probability, accuracy, volume, type, traffic) will arrive within a particular period of time (e.g., 5 ms, 10 ms).

At 1018, the WTRU 1000 determines that for the predicted UL data traffic, CA/DC is appropriate.

At 1020, while still in the RRC-INACTIVE Mode, the WTRU 1000 starts performing, and performs, one or more early measurements regarding, e.g., parameters of a UL such as data size, data throughput, number of carriers, or QoS of/for the channel(s) over which the UL is to be transmitted or received.

During an interval 1022, the WTRU 1000 continues to perform one or more early measurements.

At 1024, UL data arrives for the WTRU 1000 to transmit to the network 1002 or elsewhere.

At 1026, the WTRU 1000 sends an RRCResumeRequest to the network 1002, and, at 1028, the network sends, to the WTRU, an RRCResume message along with a request for the early measurements taken by the WTRU at 1020 and during 1022.

At 1030, the WTRU 1000 sends, to the network 1002, an RRCResumeComplete message along with a report of the early measurements taken by the WTRU at 1020 and during 1022.

At 1032, the WTRU 1000, while in the RRC-CONNECTED Mode, transmits the uplink data to the network 1002.

At 1034, the network 1002 determines whether there are available candidate cells for the WTRU 1000 to operate in a Dual-Connectivity (DC) mode.

At 1036, the network 1002 sends, to the WTRU 1000, an RRCReconfiguation message that includes, e.g., one or more CA setup configurations and/or one or more DC setup configurations, and the WTRU configures itself to operate in a CA/DC mode (or in a DC mode) accordingly.

At 1038, the WTRU 1000 is configured, and operates, in a CA/DC (or DC) mode that is suitable for the UL (and possibly other) data traffic that the WTRU is handling.

FIG. 11 is a diagram that illustrates an embodiment where a WTRU 1100 determines that there is no need for setting up CA/DC, according to an embodiment.

Referring to FIG. 11, at 1102, the WTRU 1100 is in an RRC-CONNECTED Mode.

At 1104, a network 1106 detects that the WTRU 1100 is exhibiting no activity, and at 1108, the network sends, to the WTRU, an RRCReconfiguation message that includes, e.g., a traffic-prediction-related configuration, and the WTRU configures itself to operate according to one or more of the configurations.

Alternatively, at 1110, the network 1106 sends, to the WTRU 1100, an RRCRelease message, along with one or more early-measurement configurations and traffic-prediction-related configurations, and the WTRU configures itself to operate according to one or more of the configurations.

At 1112, the WTRU 1100 enters, and is in, an RRC-INACTIVE Mode, and performs no early measurements during an interval 1114.

At 1116, the WTRU 1100 predicts that UL data having suitable prediction and data parameters (e.g., probability, accuracy, volume, type, traffic) will arrive within a particular period of time (e.g., 5 ms, 10 ms).

At 1118, the WTRU 1000 determines that for the predicted UL data traffic, CA/DC is inappropriate or otherwise not needed.

During an interval 1120, while still in the RRC-INACTIVE Mode, the WTRU 1100 does not perform early measurements.

At 1122, UL data arrives for the WTRU 1100 to transmit to the network 1106 or elsewhere.

At 1124, the WTRU 1100 sends an RRCResumeRequest to the network 1106, and, at 1126, the network sends, to the WTRU, an RRCResume message along with a request for results of early measurements that the network “believes” were taken by the WTRU.

But because the WTRU 1100 took no early measurements, at 1128, the WTRU 1100 sends, to the network 1106, an RRCResumeComplete message along with an indication that the WTRU took no early measurements. For example, the absence of an early-measurement report may signify to the network 1106 that the WTRU 1100 took no early measurements.

At 1130, the WTRU 1100, while in the RRC-CONNECTED Mode, transmits the uplink data to the network 1106.

At 1132, the network 1106 sends, to the WTRU 1100, an RRCReconfiguation message that includes, or is accompanied by one or more configurations, and the WTRU configures itself to operate in a suitable configuration accordingly.

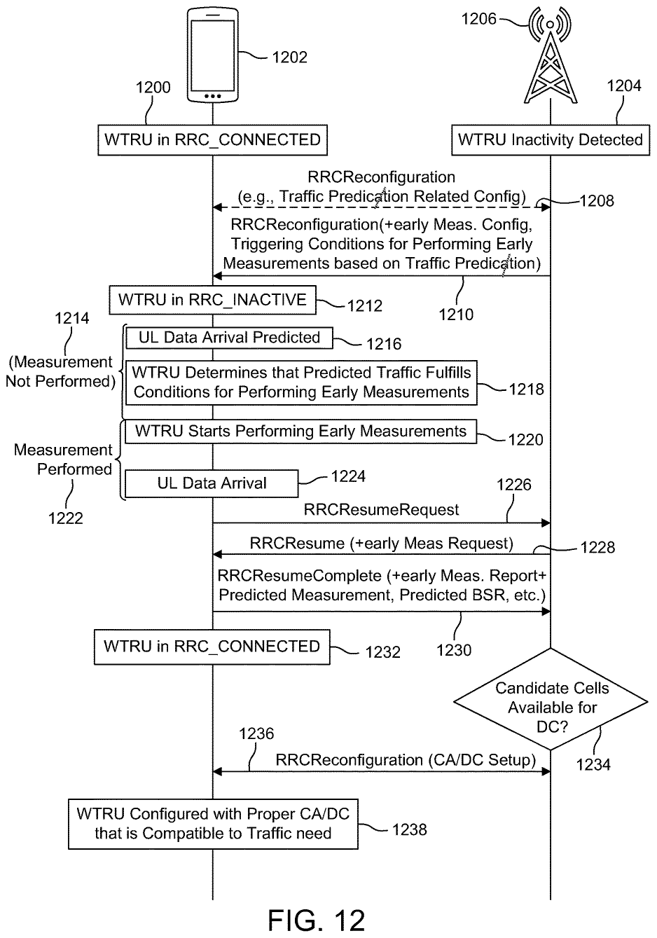

FIG. 12 is a diagram that illustrates a WTRU being provided with the configurations (while in a CONNECTED mode or upon transitioning to an INACTIVE mode) related to an early measurement configuration that is dependent on traffic prediction, according to another embodiment.

Referring to FIG. 12, at 1200, a WTRU 1202 is in an RRC-CONNECTED Mode.

At 1204, a network 1206 detects that the WTRU 1202 is exhibiting no activity, and at 1208, the network sends, to the WTRU, an RRCReconfiguation message that includes, e.g., one or more traffic-prediction-related configurations, and the WTRU configures itself to operate according to one or more of the configurations.

Alternatively, at 1210, the network 1206 sends, to the WTRU 1202, an RRCRelease message, along with one or more early-measurement configurations and/or triggering conditions for performing early measurements based on traffic prediction, and the WTRU configures itself to operate according to one or more of the configurations and/or triggering conditions.

At 1212, the WTRU 1202 enters, and is in, an RRC-INACTIVE Mode, and performs no early measurements during an interval 1214.

During the interval 1214, at 1216, the WTRU 1202 predicts that UL data having suitable predicted and data parameters (e.g., probability, accuracy, volume, type, traffic) will arrive within a particular period of time (e.g., 5 ms, 10 ms).

Still during the interval 1214, at 1218, the WTRU 1202 determines that the predicted UL data traffic fulfills at least one triggering condition for performing one or more early measurements.

At 1220, while still in the RRC-INACTIVE Mode, the WTRU 1202 commences one or more early measurements, and, during an interval 1222, the WTRU 1202 performs one or more early measurements regarding, e.g., parameters of a UL such as data size, data throughput, number of carriers, or QoS of/for the channel(s) over which the UL is to be transmitted or received.

At 1224, UL data arrives for the WTRU 1202 to transmit to the network 1206 or elsewhere.

At 1226, the WTRU 1202 sends an RRCResumeRequest message to the network 1206, and, at 1228, the network sends, to the WTRU, an RRCResume message along with a request for the one or more early measurements taken by the WTRU at 1202 and during the interval 1222.

At 1230, the WTRU 1202 sends, to the network 1206, an RRCResumeComplete message along with a report of the one or more early measurements taken by the WTRU during the interval 1222. In addition to the report, the WTRU 1202 may send to the network 1206, e.g., UL traffic predictions and a predicted BSR.

At 1232, the WTRU 1202, while in the RRC-CONNECTED Mode, transmits the uplink (UL) data to the network 1206 or elsewhere.

At 1234, the network 1206 determines whether there are available candidate cells for the WTRU 1202 to operate in a Dual-Connectivity (DC) mode.

If at 1234 the network 1206 determined that there is at least one candidate cell available for the WTRU 1202 to operate in DC mode, at 1236, the network 1206 sends, to the WTRU 1202, an RRCReconfiguation message that includes, e.g., one or more CA setup configurations and/or one or more DC setup configurations, and the WTRU configures itself to operate in a CA/DC mode (or in a DC mode) accordingly.

At 1238, the WTRU 1000 is configured, and operates, in a CA/DC (or DC) mode that is suitable for the UL (and possibly other) data traffic that the WTRU is handling.

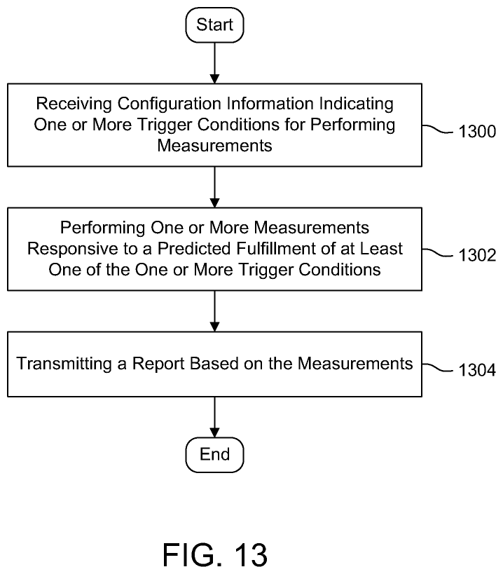

FIG. 13 is a flow diagram of a method for performing a measurement in response to fulfillment of a trigger condition and reporting the results, according to an embodiment.

At 1300, a device, such as a WTRU, receives configuration information indicating one or more trigger conditions for performing measurements. For example, the WTRU may receive the configuration information from a mobile network, the trigger conditions may include thresholds, for example, for data volume and/or channel QoS, may include data type (e.g., streaming, voice), and/or may include data arrival time, and the measurements may include, for example, channel data capacity and/or throughput, channel QoS, channel fade, and/or carriers available on a channel.

At 1302, the WTRU performs one or more measurements responsive to a predicted fulfillment of at least one of the one or more trigger conditions. For example, the WTRU may execute a prediction algorithm to predict one or more conditions, for example arrival time of UL/DL data, volume of UL/DL data, and/or type of UL/DL, and, if at least one of the one or more predicted conditions meets a respective threshold, then the WTRU makes at least one of the one or more measurements. For example, a predicted data volume may equal or exceed a threshold needed for the WTRU to make one or more measurements, a predicted data arrival time may equal or be less than a threshold needed for the WTRU to make one or more measurements, and/or a predicted data type may be of a type needed for the WTRU to make one or more measurements.

And, at 1304, the WTRU transmits, for example to a mobile network, a report based on the taken one or more measurements. For example, the report may include at least one of the one or more of the measurements, and/or may include the condition-prediction result(s).

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method implemented in a wireless transmit/receive unit (WTRU), the method comprising:
receiving configuration information indicating a trigger condition for measurements to be performed while operating in a first activity level;
receiving an indication to transition from operating in a second activity level to operating in the first activity level;
performing measurements, while operating in the first activity level, responsive to a predicted fulfillment of the trigger condition; and
transmitting a report based on the measurements responsive to transitioning to the second activity level.

2. The method of claim 1, wherein the trigger condition comprises a threshold amount of uplink traffic.

3. The method of claim 1, wherein the predicted fulfillment of the trigger condition comprises a prediction that uplink traffic will exceed a threshold.

4. The method of claim 1, wherein the prediction and the measurements are performed during an inactive state.

5. (canceled)

6. The method of claim 1, wherein the report includes an indication of the measurements, an indication of current uplink traffic, or an indication of predicted uplink traffic.

7. The method of claim 1, wherein the report includes an indication for preference of Carrier Aggregation (CA) or Dual Connectivity (DC).

8. The method of claim 7, wherein the indication is included in one or more of a connection-establishment-request message, a connection-resume-request message, a connection-establishment-complete message, or a connection-resume-complete message sent by the WTRU during or after the transition to the second activity level.

9. (canceled)

10. The method of claim 1, further comprising transmitting an indication of a traffic-prediction capability of the WTRU and receiving the configuration information responsive to the indication of the traffic-prediction capability of the WTRU.

11. The method of claim 1, wherein the configuration information includes information for performing the prediction.

12. The method of claim 11, wherein the information for performing the prediction includes a configuration for an artificial intelligence machine learning (AI/ML) model or an indication of an AI/ML model.

13. (canceled)

14. (canceled)

15. A wireless transmit/receive unit (WTRU) comprising:
circuitry configured to receive configuration information indicating a trigger condition for measurements to be performed while operating in a first activity level;
circuitry configured to receive an indication to transition from operating in a second activity level to operating in the first activity level;
circuitry configured to perform measurements, while operating in the first activity level, responsive to a predicted fulfillment of the trigger condition; and
circuitry configured to transmit a report based on the measurements responsive to transitioning to the second activity level.

16. The WTRU of claim 15, wherein the trigger condition comprises a threshold amount of uplink traffic.

17. The WTRU of claim 15, wherein the predicted fulfillment of the trigger condition comprises a prediction that uplink traffic will exceed a threshold.

18. The WTRU of claim 15, wherein the prediction and the measurements are performed during an inactive state.

19. (canceled)

20. The WTRU of claim 15, wherein the report includes an indication of the measurements, an indication of current uplink traffic, or an indication of predicted uplink traffic.

21. The WTRU of claim 15, wherein the report includes an indication for implementation of Carrier Aggregation (CA) or Dual Connectivity (DC).

22. The WTRU of claim 15, wherein the indication is included in one or more of a connection-establishment-request message, a connection-resume-request message, a connection-establishment-complete message, or a connection-resume-complete message sent by the WTRU during or after the transition to the second activity level.

23. (canceled)

24. The WTRU of claim 15, further configured to transmit an indication of a traffic-prediction capability of the WTRU and to receive the configuration information responsive to the indication of the traffic-prediction capability of the WTRU.

25. The WTRU of claim 15, wherein the configuration information includes information for performing the prediction.

26. The WTRU of claim 25, wherein the information for performing the prediction includes a configuration for an artificial intelligence machine learning (AI/ML) model or an indication of an AI/ML model.

27. (canceled)

28. (canceled)
